(19) United States
(12) Patent Application Publication
(10) Pub. No.: US 2026/0190121 A1
(43) Pub. Date: Jul. 2, 2026

(54) METHOD AND DEVICE FOR RECEIVING AND TRANSMITTING INFORMATION IN WIRELESS COMMUNICATION SYSTEM

(71) Applicant: Samsung Electronics Co., Ltd., Suwon-si, Gyeonggi-do (KR)

(72) Inventors: Zhe CHEN, Beijing (CN); Feifei SUN, Beijing (CN); Bin YU, Beijing (CN)

(21) Appl. No.: 19/131,139

(22) PCT Filed: Nov. 24, 2023
(86) PCT No.: PCT/KR2023/019131

§ 371 Date: May 19, 2025

(30) Foreign Application Priority Data
Dec. 29, 2022 (CN) 202211714606.2
Apr. 14, 2023 (CN) 202310402887.6
Apr. 25, 2023 (CN) 202310456691.5
Oct. 10, 2023 (CN) 202311307983.9

(51) Int. Cl. H04W 72/232; H04W 16/26; H04W 72/0446; H04W 72/563

(52) U.S. Cl. CPC H04W 72/232; H04W 16/26; H04W 72/0446; H04W 72/563

(57) ABSTRACT

The disclosure relates to a 5G or 6G communication system for supporting a higher data transmission rate. The disclosure provides a method and device for receiving and transmitting information. Specifically, a method performed by a repeater NCR including 2024/143928 a mobile terminal NCR-MT and a forwarder NCR-Fwd in a communication system is provided, the method including: receiving, by the NCR-MT, a beam failure recovery response from a network node; and after the NCR-MT receives the beam failure recovery response, performing, by the NCR-Fwd at least one of the following operations: using, by the NCR-Fwd, a spatial domain filter associated with an index q_{new} for downlink reception and/or uplink forwarding; using, by the NCR-Fwd, a spatial domain filter used in a last physical random access channel PRACH transmission of the NCR-MT for the uplink forwarding.

### TECHNICAL FIELD

The present disclosure relates to the technical field of wireless communication, and more specifically, to a method and device for receiving and transmitting information.

### BACKGROUND ART

5G mobile communication technologies define broad frequency bands such that high transmission rates and new services are possible, and can be implemented not only in “Sub 6GHz” bands such as 3.5GHz, but also in “Above 6GHz” bands referred to as mm Wave including 28GHz and 39GHz. In addition, it has been considered to implement 6G mobile communication technologies (referred to as Beyond 5G systems) in terahertz (THz) bands (for example, 95GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

The transmission from a base station to a User Equipment (UE) is referred to as downlink, and the transmission from a UE to a base station is referred to as uplink.

### DISCLOSURE OF INVENTION

### Solution to Problem

When the link quality of the control link and/or backhaul link of the repeater reduces, the signal forwarding quality of the repeater will be affected. The disclosure proposes a repeater (called a network-controlled repeater (NCR)) integrated with a terminal device and an operation method thereof to solve the above problems.

An aspect of the disclosure provides a method performed by a repeater NCR including a mobile terminal NCR-MT and a forwarder NCR-Fwd in a communication system, the method including: receiving, by the NCR-MT, a beam failure recovery response from a network node; and after the NCR-MT receives the beam failure recovery response, performing, by the NCR-Fwd at least one of the following operations: using, by the NCR-Fwd, a spatial domain filter associated with an index q_{new} for downlink reception and/or uplink forwarding; using, by the NCR-Fwd, a spatial domain filter used in a last physical random access channel PRACH transmission of the NCR-MT for the uplink forwarding.

In an example, after the NCR-MT receives the beam failure recovery response, the NCR-Fwd performs the at least one operation until the NCR-MT receives a spatial domain indication or the spatial domain indication is applied by the NCR; wherein the spatial domain indication includes at least one of: a first spatial domain indication for the NCR-MT; a second spatial domain indication for the NCR-Fwd; an earlier indication of the first spatial domain indication and the second spatial domain indication.

In an example, if the NCR-MT is not configured with a downlink transmission configuration indicator TCI state list parameter or a joint TCI state list parameter, the NCR-Fwd uses the spatial domain filter associated with the index q_{new} for the downlink reception and/or uses the spatial domain filter used in the last PRACH transmission of the NCR-MT for the uplink forwarding; or if the NCR-MT is configured with the downlink TCI state list parameter or the joint TCI state list parameter, the NCR-Fwd uses the spatial domain filter associated with the index q_{new} for the downlink reception and the uplink forwarding; or the NCR-Fwd uses the spatial domain filter associated with the index q_{new} for the downlink reception, and uses the spatial domain filter used in the last PRACH transmission of the NCR-MT for the uplink forwarding.

In an example, the method further includes: if the spatial domain indication is the first spatial domain indication, and/or the NCR-MT does not receive the second spatial domain indication, after the NCR-MT receives information on the spatial domain indication, the NCR-Fwd uses a spatial domain filter associated with a quasi co-location QCL hypothesis of a control resource set CORESET with a smallest index on an active bandwidth part BWP of the NCR-MT for the downlink reception or the uplink forwarding.

In an example, the first spatial domain indication includes a TCI state indication for downlink control channel reception of the NCR-MT; and/or the second spatial domain indication includes a TCI state indication for the downlink reception of the NCR-Fwd.

In an example, the method further includes: if the spatial domain indication is the first spatial domain indication, and/or the NCR-MT does not receive the second spatial domain indication, after the NCR-MT receives information on the spatial domain indication, the NCR-Fwd uses a spatial domain filter associated with a spatial relation of a physical uplink control channel PUCCH resource with a smallest index on an active BWP of the NCR-MT for the uplink forwarding.

In an example, the first spatial domain indication includes a spatial relation indication for physical uplink control channel forwarding of the NCR-MT; and/or the second spatial domain indication includes a sounding reference signal resource indicator SRI for uplink channel forwarding of the NCR-Fwd.

In an example, the method further includes: if the spatial domain indication is the first spatial domain indication, and/or the NCR-MT does not receive the second spatial domain indication, after the NCR-MT receives information on the spatial domain indication, the NCR-Fwd uses a spatial domain filter associated with a TCI state indicated by the first spatial domain indication for the downlink reception and the uplink forwarding.

In an example, the first spatial domain indication includes a joint TCI state indication for signals and/or channels of the NCR-MT; and/or the second spatial domain indication includes a TCI state indication for the uplink forwarding and the downlink reception of the NCR-Fwd.

In an example, the method further includes: if the spatial domain indication is the second spatial domain indication, after the NCR-MT receives information on the spatial domain indication, the NCR-Fwd uses a spatial domain filter associated with a TCI state and/or an SRI of the spatial domain indication for the uplink forwarding and/or the downlink reception.

In an example, the NCR-Fwd performs the operation after a predefined time from the NCR-MT receiving the beam failure recovery response, wherein a subcarrier spacing of the predefined time is determined according to a subcarrier interval of a downlink active BWP for reception of the beam failure recovery response and/or a subcarrier spacing associated with the NCR-Fwd.

In an example, the beam failure recovery response includes at least one of: a downlink control information format detected in a search space configured by a recovery search space parameter and with cyclic redundancy check CRC scrambled by a cell radio network temporary identifier C-RNTI or a modulation and demodulation scheme cell radio network temporary identifier MCS-C-RNTI; a physical downlink control channel (PDCCH) used to determine end of a contention-based random access procedure.

In an example, when the NCR-MT and the NCR-Fwd do not perform downlink reception or uplink transmission simultaneously, the NCR-Fwd performs the at least one operation.

In an example, the NCR-MT supports reception of the second spatial domain indication.

An aspect of the disclosure provides a method performed by a network node in a communication system, the method including: transmitting a beam failure recovery response to a repeater; and performing downlink transmission and/or uplink reception, wherein the beam failure recovery response is used for a forwarder NCR-Fwd in the repeater to perform at least one of the following operations: using a spatial domain filter associated with an index q_{new} for downlink reception and/or uplink forwarding; using a spatial domain filter used in a last physical random access channel PRACH transmission of the NCR-MT for the uplink forwarding.

An aspect of the disclosure provides a repeater NCR in a wireless communication system, the NCR including a first unit and a second unit, and configured to perform the methods that can be performed by the NCR in the above various aspects.

An aspect of the disclosure provides a repeater NCR in a wireless communication system, the NCR including: a transceiver; and a controller coupled to the transceiver and configured to perform the methods that can be performed by the NCR in the above various aspects.

An aspect of the disclosure provides a network node in a wireless communication system, the network node including: a transceiver; and a controller coupled to the transceiver and configured to perform the various methods that can be performed by the network node in the above various aspects.

### Advantageous Effects of the Invention

The disclosure provides a method and device for receiving and transmitting in-formation/signals, which can adjust the beam used for forwarding after the NCR receives the beam response, thereby improving the quality of NCR forwarding signals and further improving the reliability of the communication system.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

The above and other aspects, features and advantages of the disclosure will be more apparent from the following detailed description when taken in conjunction with the accompanying drawings.

FIG. 1 illustrates an overall structure of an example wireless communication network according to various embodiments of the disclosure;

FIGS. 2A and 2B illustrate a transmission path 200 and a reception path 250 in a wireless communication network according to various embodiments of the disclosure respectively;

FIGS. 3A and 3B illustrate structures of a user equipment (UE) and a base station in a wireless communication network according to various embodiments of the disclosure respectively;

FIG. 4A illustrates an example network including a repeater according to various embodiments of the disclosure, and FIG. 4B illustrates an example structure of an NCR according to various embodiments of the disclosure;

FIG. 5 illustrates a flowchart of a method 500 performed by a repeater according to various embodiments of the disclosure;

FIG. 6 illustrates a flowchart of a method 600 performed by a network device according to various embodiments of the disclosure;

FIG. 7 illustrates a structure 700 of a repeater according to various embodiments of the disclosure;

FIG. 8 illustrates a structure 800 of a network device according to various embodiments of the disclosure.

FIG. 9 illustrates a structure of a device according to embodiments of the disclosure.

### Best Mode for Carrying out the Invention

Aspects of the disclosure are to address at least the above-mentioned problems and/or disadvantages and to provide at least the advantages described below. Accordingly, an aspect of the disclosure is to provide a terminal and a communication method thereof in a wireless communication system.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to their bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be understood that “first”, “second” and similar words used in the disclosure do not express any order, quantity or importance, but are only used to distinguish different components.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the application can be applied to future-oriented communication technologies. In addition, the technical schemes of the embodiments of the application can be applied to future-oriented communication technologies.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”

Hereinafter, embodiments of the disclosure will be described in detail with reference to the accompanying drawings. It should be noted that in the drawings, the same or similar elements are denoted by the same or similar reference numerals as far as possible. In addition, detailed descriptions of known functions or configurations that may make the subject matter of the disclosure unclear will be omitted.

When describing the embodiments of the disclosure, descriptions related to technical contents that are well known in the art and not directly related to the disclosure will be omitted. Such omitting of unnecessary description is to prevent the main idea of the disclosure from being blurred and to convey the main idea more clearly.

For the same reason, some elements may be exaggerated, omitted or schematically shown in the drawings. In addition, the size of each element does not fully reflect the actual size. In the drawings, the same or corresponding elements have the same reference numerals.

Advantages and features of the disclosure and ways to achieve them will become clear by referring to the embodiments described in detail below in conjunction with the accompanying drawings. However, the disclosure is not limited to the embodiments set forth below, but can be implemented in various forms. The following examples are provided only to fully disclose the disclosure and to inform those skilled in the art of its scope, and the disclosure is only limited by the scope of the appended claims. Throughout this specification, the same or similar reference numerals indicate the same or similar elements.

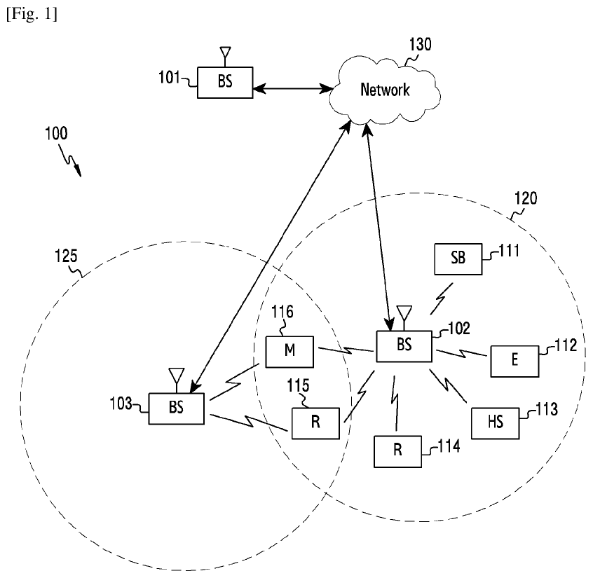

FIG. 1 illustrates an example wireless network 100 according to various embodiments of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

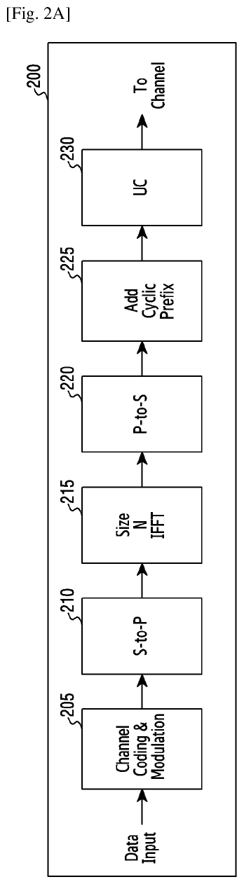

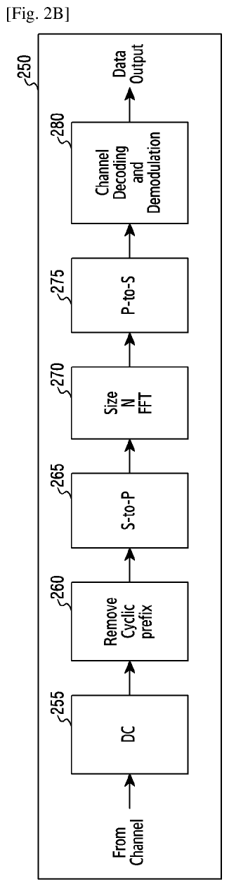

FIGS. 2A and 2B illustrate example wireless transmission and reception paths according to the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

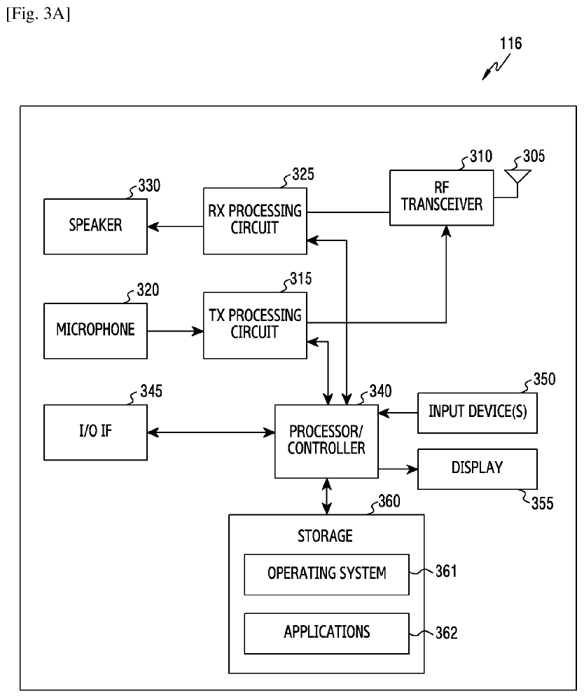

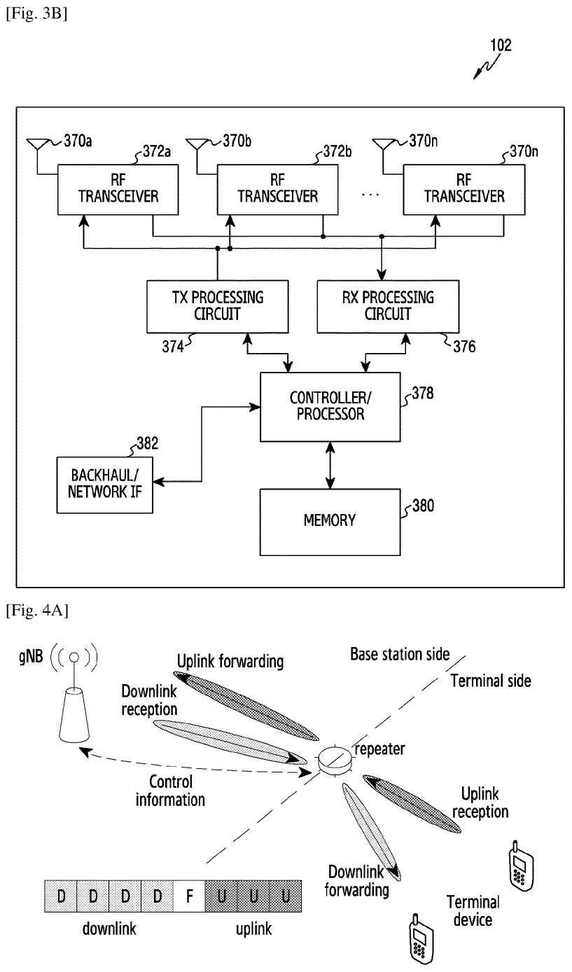

FIG. 3A illustrates an example UE 116 according to the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370 a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

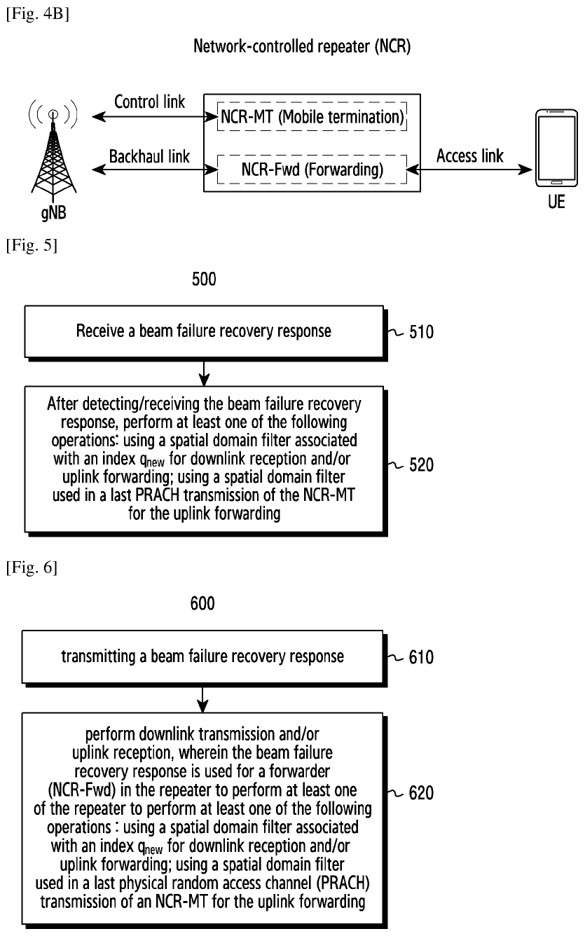

In order to enhance the coverage of the 5G wireless communication system, one implementation is to set up a repeater at an edge of a cell (or in an area with poor cell signal coverage). Generally, the repeater is usually divided into two sides, a base station side and a terminal side. FIG. 4A illustrates an example network including a repeater according to various embodiments of the disclosure. As shown in FIG. 4A, for a downlink of the base station, the repeater receives radio frequency (RF) signals from the base station at the base station side. These RF signals pass through a built-in amplifier in the repeater and the amplified signals are transmitted to a terminal device at the terminal side of the repeater. For an uplink of the base station, the repeater receives radio frequency (RF) signals from the terminal device at the terminal side. These RF signals pass through a built-in amplifier in the repeater and the amplified signals are transmitted to the base station at the base station side of the repeater.

Generally, the existing repeater cannot be controlled by a base station. That is, the switch of the repeater, the time of uplink and downlink forwarding and the direction of uplink and downlink forwarding are all achieved by the way of the technology implemented by the repeater itself/manual setting adjustment, which is not beneficial to the flexibility of network distribution and the coverage of the repeater. In order to overcome the above shortcomings, a solution is to integrate a terminal device for the repeater, which can communicate with network devices (for example, a base station) in order to flexibly control the repeater. Such repeater integrated with a terminal device is called a network-controlled repeater, i.e., NCR.

FIG. 4B illustrates an example structure of an NCR according to various embodiments of the disclosure. As shown in FIG. 4B, the NCR has two functional entities: a first unit and a second unit. It can be understood that in the disclosure, the repeater (NCR) and its name are only exemplary and not restrictive. In the disclosure, an example of the first unit is a repeater mobile terminal (NCR-MT), and an example of the second unit is a repeater forwarder (NCR-Fwd), in which:
the NCR-MT is defined as a functional entity for information/signal exchange (e.g., side control information) with network nodes (e.g., a base station). Here, the link between the NCR-MT and the base station is called a control link (C-link). Optionally, the side control information is at least used to control the NCR-Fwd.
the NCR-Fwd is defined as a functional entity for amplifying-and-forwarding radio frequency signals (e.g., uplink/downlink radio frequency signals) between a base station and a UE. The link between the NCR-Fwd and the base station is called a backhaul link; and the link between the NCR-Fwd and the UE is called an access link.

In the disclosure, the NCR may refer to NCR-MT or NCR-Fwd, or a combination of both. Optionally, the NCR-MT may also be understood as a UE, that is, it may be understood as a terminal device.

In order to avoid ambiguity, here, the corresponding names are defined for the transmitting and/or receiving behaviors of the repeater. Referring back to FIG. 4A, for the NCR, or for the NCR-Fwd, reception of downlink radio frequency signal (or radio frequency signal reception at the base station side; or radio frequency signal reception on the backhaul link) is called downlink reception; transmission of downlink radio frequency signals (or radio frequency signal transmission at the terminal side; or radio frequency signal forwarding to the terminal; or radio frequency signal transmission on the access link) is called downlink forwarding; reception of uplink radio frequency signals (or radio frequency signal reception at the terminal side; or radio frequency signal reception on the access link) is called uplink reception; transmission of uplink radio frequency signal (or radio frequency signal transmission at the base station side; or forwarding of radio frequency signals to the base station; or radio frequency signal transmission on the backhaul link) is called uplink forwarding.

When the link quality of the control link and/or backhaul link of the NCR reduces, the signal forwarding quality of the NCR will be affected.

In order to solve the above problems, the disclosure proposes corresponding methods. By these methods, the link quality reduction of the control link and/or the backhaul link can be alleviated or avoided, thereby improving the signal forwarding quality of the NCR, and further improving the reliability of the communication system.

Further explanation is made below by way of example.

Firstly, beam management process for an NCR-MT is described.

In an implementation, an NCR-MT receives configuration information from a network device and performs a corresponding beam failure recovery procedure according to the configuration information. The beam failure recovery procedure of the NCR-MT is described below by way of example in which a beam failure recovery response is a downlink control information (DCI) format with cyclic redundancy check (CRC) scrambled by a cell radio network temporary identifier (C-RNTI) or modulation and demodulation scheme cell radio network temporary identifier (MCS-C-RNTI).

Each bandwidth part (BWP) of each serving cell of the NCR-MT may be provided with a set (q₀) of periodic channel state information reference signal (CSI-RS) resource configuration indexes by a failure detection resource list parameter (for example, fail-ureDetectionResourcesToAddModList); optionally, it may be provided with a set (q₁) of periodic CSI-RS resource configuration indexes and/or synchronization signal block (SSB) indexes used for radio link quality measurement on the BWP of the serving cell by a candidate beam reference signal list parameter (for example, candidate-BeamRSList or candidateBeamRSListExt).

The NCR-MT is not provided with q₀ by the failure detection resource list parameter in the BWP of the serving cell, the NCR-MT determines that q₀ includes a periodic CSI-RS resource configuration index with a same index value as that of a reference signal (in a reference signal group indicated by a transmission control indication (TCI) state of a CORESET used by the NCR-MT to detect a physical downlink control channel (PDCCH)).

If there are two reference signal indexes in a TCI state, q₀ includes quasi co-location (QCL) type D (for example, qcl-Type is set to “typed”) reference signal indexes in a TCI state corresponding to q₀.

The NCR-MT expects that q₀ includes at most two reference signal indexes. For example, q₀ provided/configured for the NCR-MT includes at most two reference signal indexes.

The NCR-MT expects that reference signals in q₀ are single-port reference signals. For example, the reference signals in q₀ provided/configured for the NCR-MT are single-port.

The NCR-MT expects that reference signals in q1 are single-port reference signals or two-port reference signals with a frequency-domain density equal to 1 resource element (RE) (or 3 resource elements) in each resource block (RB). For example, the reference signals in q1 provided/configured for the NCR-MT are single-port reference signals or two-port reference signals with a frequency-domain density equal to 1 resource element (RE) (or 3 resource elements) in each resource block (RB).

A threshold Q_{out,LR} corresponds to a default value of a block error rate (BLER) threshold parameter (the threshold Q_{out,LR} is determined according to the default value). The BLER threshold parameter is a BLER threshold pair index (for example, rlmIn-SyncOutOfSyncThreshold) used for synchronization/out-of-sync indication generation. A threshold Q_{in,LR} corresponds to a value provided by a layer 1 reference signal received power (L1-RSRP) threshold parameter. The L1-RSRP threshold parameter (for example, rsrp-ThresholdSSB or rsrp-ThresholdBFR) refers to an L1-RSRP threshold used to determine whether a candidate beam can be used by a UE.

The physical layer in the NCR-MT assesses the radio link quality according to the set q₀ of resource configurations against the threshold Q_{out,LR}.

For q₀, the NCR-MT only assesses the radio link quality according to SSB or periodic CSI-RS resource configurations of a primary cell (PCell) or a primary secondary cell (PSCell). The SSB or CSI-RS is quasi co-located with a demodulation reference signal (DM-RS) for PDCCH reception of the NCR-MT. The NCR-MT applies the threshold Q_{in,LR} to measurement results of the L1-RSRP acquired from the SSB. The NCR-MT applies the threshold Q_{in,LR} to measurement results of the L1-RSRP acquired from the CSI-RS after scaling a respective CSI-RS reception power with a value provided by a power offset parameter. The power offset parameter (for example, powerControlOffsetSS) refers to a power offset between a non-zero power channel state information reference signal resource element (NZP CSI-RS RE) and a secondary synchronization signal resource element (SSS RE).

In an operation of a discontinuous reception (DRX) mode, when the radio link quality of all resource configurations used by the NCR-MT to assess the radio link quality in q₀ is lower than the threshold Q_{out,LR}, the physical layer in the NCR-MT provides an indication to a higher layer. When the radio link quality is lower than the threshold Q_{out,LR}, the physical layer notifies the higher layer at one cycle. The cycle is determined according to a maximum value of one of:
a shortest cycle of a cycle of the SSB of the PCell/PSCell used by the NCR-MT to assess the radio link quality and/or a cycle of a periodic CSI-RS configuration in q₀;
2 milliseconds.

In the operation of the DRX mode, when the radio link quality is lower than the threshold Q_{out,LR}, the physical layer in the NCR-MT provides an indication to the higher layer at one cycle.

For the PCell or PSCell, after receiving a request from the higher layer, the NCR-MT provides the higher layer with indexes of periodic reference signals and/or indexes of SSBs with an L1-RSRP measurement greater than or equal to the threshold Q_{in,LR} in q1, and the NCR-MT provides the higher layer with the L1-RSRP measurement (e.g., a measurement value) corresponding to the indexes of the periodic reference signals and/or the indexes of the SSBs.

In an implementation, a higher layer (e.g., a media access control (MAC) layer) in the NCR-MT provides an index q_{new} to (the physical layer in) the NCR-MT. Optionally, the index q_{new} is selected by the higher layer in the NCR-MT from the set q₁. Optionally, the index q_{new} is selected from the indexes of the periodic reference signals and/or the indexes of the SSBs with the L1-RSRP measurement greater than or equal to the threshold Q_{in,LR} in q₁ provided by the NCR-MT to the higher layer.

For the PCell or PSCell, the NCR-MT can be configured with a control resource set (CORESET) through a link to a search space set. The search space set is provided by a recovery search space parameter (for example, recoverySearchSpaceId). The recovery search space parameter is used to indicate a search space for beam failure recovery random access feedback (RAR).

For the PCell or a PSCell, the NCR-MT can be provided with a physical random access channel (PRACH) transmission configuration through a PRACH resource parameter. The PRACH resource parameter (for example, PRACH-Re-sourceDedicatedBFR) is used to configure dedicated resources for beam failure recovery (for example, dedicated reference signal resources). For a PRACH transmission in slot n and according to an antenna port quasi co-location parameter (for example, the antenna port quasi co-location parameter is associated with the periodic CSI-RS configuration index or SSB index q_{new} provided by the higher layer), the NCR-MT monitors a PDCCH in a window on a CORESET associated with a search space set provided by the recovery search space parameter. The window is configured by a beam failure recovery parameter (for example, BeamFailureRecoveryConfig), and the window is used to detect a downlink control information format with CRC scrambled by a C-RNTI or MCS-C-RNTI from slot n+4. For the PDCCH monitoring and the corresponding PDCCH reception in the search space configured by the recovery search space parameter, the NCR-MT determines/considers that the antenna port quasi co-location parameter is the same as the antenna port quasi co-location parameter associated with q_{new}, until the NCR-MT receives activation of a TCI state of the higher layer or any physical downlink control channel TCI state parameters (for example, tci-StatesPDCCH-ToAddList and/or tci-StatesPDCCH-ToReleaseList). The physical downlink control channel TCI state parameter is used to provide a quasi co-location relationship between a downlink reference signal (or TCI state) and a PDCCH demodulation reference signal port.

When the NCR-MT detects a downlink control information format with CRC scrambled by a C-RNTI or MCS-C-RNTI in the search space configured by the recovery search space parameter, the NCR-MT continues to monitor PDCCH candidates in the search space until the NCR-MT receives a MAC-CE activation command for a TCI state or physical downlink control channel TCI state parameters (for example, tci-StatesPDCCH-ToAddList and/or tci-StatesPDCCH-ToReleaseList).

For the PCell or a PSCell, after 28 symbols from the last symbol for the PDCCH reception in the search space configured by the recovery search space parameter (for example, the search space for the NCR-MT to detect a downlink control information format with CRC scrambled by a C-RNTI or MCS-C-RNTI), until the NCR-MT receives a MAC-CE activation command or the NCR-MT is provided with a PUCCH spatial relation parameter (for example, PUCCH-SpatialRelationInfo) for physical uplink control channel (PUCCH) resources, the NCR-MT transmits a PUCCH on a same cell as a last PRACH transmission using a same spatial domain filter (which may also be called a spatial filter) as the last PRACH transmission.

For the PCell or a PSCell (and for q₀ and q₁), after 28 symbols from the last symbol for the PDCCH reception in the search space configured by the recovery search space parameter (for example, the search space for the NCR-MT to detect a downlink control information format with CRC scrambled by a C-RNTI or MCS-C-RNTI), the NCR-MT determines/considers that the antenna port quasi co-location parameter for the PDCCH monitoring in a CORESET with an index of 0 and the antenna port quasi co-location parameter associated with the index q_{new} are the same.

If the NCR-MT is provided with a TCI state parameter (for example, TCI-State_r17 or TCI-State) to indicate a unified TCI state acting on the PCell or PSCell, after 28symbols from the last symbol for the PDCCH reception in the search space configured by the recovery search space parameter (for example, the search space for the NCR-MT to detect a downlink control information format with CRC scrambled by a C-RNTI or MCS-C-RNTI):
if an SSB measurement time configuration parameter (for example, SSB-MTC-AdditionalPCI) is not provided, the NCR-MT monitors the PDCCH in all CORESETs using a same antenna quasi co-location parameter as the antenna port quasi co-location parameter associated with the index q_{new}, and receives a physical downlink shared channel (PDSCH) and (if there are CSI-RS resources described below) receives aperiodic CSI-RS resources in a CSI-RS resource group (where the CSI-RS resource group has a same indicated TCI state as that for the PDCCH and PDSCH).
the NCR-MT transmits a physical uplink shared channel (PUSCH), a physical uplink control channel (PUCCH) and a sounding reference signal (SRS) using a same spatial domain filter as that for the latest PRACH transmission. The SRS refers to an SRS that uses a same spatial domain filter as the PUSCH and the PUCCH and has a same indicated TCI state.

In an implementation, an NCR-MT receives configuration information from a network device and performs a corresponding beam failure recovery procedure according to the configuration information. The beam failure recovery procedure of the NCR-MT is described below by way of example in which a beam failure recovery response is a downlink control information format for determining a contention-based random access procedure. The way in which the NCR-MT receives the configuration information from the network device is the same as the above implementation in which the beam failure response is the downlink control information format with CRC scrambled by a C-RNTI or MCS-C-RNTI, which will not be repeated here.

For the PCell or a PSCell, if a beam failure recovery MAC-CE is provided by Message 3(Msg3 ) or Message A (MsgA) of the contention-based random access procedure, and PUCCH resources are provided with the PUCCH spatial relation parameter, after 28 symbols from the last symbol for PDCCH reception for determining the end of the contention-based random access procedure, the NCR-MT transmits a PUCCH on the same cell as the last PRACH transmission using the same spatial domain filter as the last PRACH transmission.

If the NCR-MT is provided with a TCI state parameter (for example, a downlink or joint TCI state list parameter (dl-OrJoint-TCIStateList-r17) or an uplink TCI state parameter (UL-TCIstate)) to indicate a unified TCI state acting on the PCell or PSCell, and the NCR-MT provides the beam failure recovery MAC-CE in Msg3 or MsgA of the contention-based random access procedure, after 28 symbols from the last symbol for PDCCH reception for determining the end of the contention-based random access procedure:
if an SSB measurement time configuration parameter (for example, SSB-MTC-AdditionalPCI) is not provided, the NCR-MT monitors the PDCCH in all CORESETs using a same antenna quasi co-location parameter as the antenna port quasi co-location parameter associated with the index q_{new}, and receives a PDSCH and (if there are CSI-RS resources described below) receives aperiodic CSI-RS resources in a CSI-RS resource group (where the CSI-RS resource group has a same indicated TCI state as that for the PDCCH and PDSCH).
the NCR-MT transmits a PUSCH, a PUCCH and an SRS using a same spatial domain filter as that for the latest PRACH transmission. The SRS refers to an SRS that uses a same spatial domain filter as the PUSCH and the PUCCH and has a same indicated TCI state.

The behavior of an NCR-Fwd in the beam failure recovery procedure of the NCR-MT is described below by way of example. Optionally, the behavior of the NCR-Fwd is applicable to frequency range 2(FR2), or when an NCR is (operating) in the FR2, the behavior of the NCR-Fwd is as follows. Optionally, when (TCI state configurations of) the NCR-MT is configured with a quasi co-location type D reference signal, the behavior of the NCR-Fwd is as follows.

FIG. 5 illustrates a method 500 performed by an NCR according to various embodiments of the disclosure. The method 500 includes: at 510, an NCR-MT receives a beam failure recovery response, and at 520, after the NCR-MT detects/receives the beam failure recovery response (for example, after a predefined time after the NCR-MT detects the beam failure recovery response), an NCR-Fwd performs at least one of the following operations: the NCR-Fwd using a spatial domain filter associated with an index q_{new} for downlink reception and/or uplink forwarding (or the NCR-Fwd using a spatial domain filter associated with an index q_{new} for downlink reception and/or uplink forwarding); the NCR-Fwd using a spatial domain filter used in a last PRACH transmission of the NCR-MT for the uplink forwarding.

### EXAMPLE 1

In this example, a behavior of the NCR-Fwd is described by way of example in which the NCR-MT is configured with a Rel- 15/16 beam management framework. The NCR-MT being configured with the Rel- 15/16 beam management framework means/may be understood as at least one of:
the NCR-MT being not provided/configured with a downlink or joint TCI state list parameter (for example, dl-OrJoint-TCIStateList or dl-OrJoint-TCIStateList-r17);
the NCR-MT being not provided/configured with an uplink TCI state parameter (for example, UL-TCIstate);
the NCR-MT being not provided/configured with a downlink or joint TCI state list parameter (for example, dl-OrJoint-TCIStateList or dl-OrJoint-TCIStateList-r17) for indicating a unified TCI state (for PCell or PSCell);
the NCR-MT being not provided/configured with an uplink TCI state parameter (for example, UL-TCIstate) for indicating the unified TCI state (for PCell or PSCell);
the NCR-MT being not provided/configured with a TCI state parameter (for example, TCI-State_r17 or TCI-State) for indicating the unified TCI state (for PCell or PSCell).

An example in which the NCR-MT is not provided/configured with the downlink or joint TCI state list parameter is described.

An example in which a beam failure recovery response is a PDCCH in a downlink control information format with CRC scrambled by a C-RNTI or MCS-C-RNTI is described. The beam failure recovery response may also be a PDCCH used to determine end of a contention-based random access procedure. Optionally, the NCR-MT is further provided with a beam failure recovery MAC-CE in Message 3(Msg3 ) or Message A (MsgA) of the contention-based random access procedure. The beam failure recovery response may also be other channels or signals, and the method is not limited thereto.

Optionally, the NCR-MT is not provided/configured with the downlink or joint TCI state list parameter.

At least one of the following methods is used to determine the behavior of the NCR-Fwd (downlink reception):

### Method 1

(For a PCell or PSCell,) after a predefined time (for example, 28 symbols) from PDCCH reception (for example, a last symbol for the PDCCH reception) of the NCR-MT in a search space (for example, a search space configured by a recovery search space parameter, for another example, a search space for the NCR-MT to detect a downlink control information format with CRC scrambled by a C-RNTI or MCS-C-RNTI) or a time reported based on an NCR-MT capability, the NCR-Fwd determines/uses a spatial domain filter associated with an index q_{new} (or an antenna port quasi co-location parameter) for/to perform downlink reception.

Optionally, before the NCR-MT detects a downlink control channel (for example, corresponding to a downlink control information format with CRC scrambled by a C-RNTI or MCS-C-RNTI) in the search space (for example, the search space configured by the recovery search space parameter), the NCR-Fwd determines/uses a spatial domain filter associated with a quasi co-location hypothesis (or a TCI state) of a CORESET with a smallest index in an active BWP of the NCR-MT for/to perform downlink reception.

### Method 2

(For a PCell or PSCell,) after a predefined time (for example, 28 symbols) from PDCCH reception (for example, a last symbol for the PDCCH reception) of the NCR-MT in a search space (for example, a search space configured by a recovery search space parameter, for another example, a search space for the NCR-MT to detect a downlink control information format with CRC scrambled by a C-RNTI or MCS-C-RNTI) or a time reported based on an NCR-MT capability, until the NCR-MT receives a spatial domain indication or until the NCR-MT applies the spatial domain indication (or before the spatial domain indication), the NCR-Fwd determines/uses a spatial domain filter associated with an index q_{new} (or an antenna port quasi co-location parameter) for/to perform downlink reception.

The above spatial domain indication is a first spatial domain indication (or spatial domain update indication) for (signals or channels of) the NCR-MT. For example, a media access control element (MAC-CE) activation command for a TCI state (for a physical downlink control channel). For another example, a physical downlink control channel TCI state parameter for the NCR-MT (for example, tci-StatesPDCCH-ToAddList and/or tci-StatesPDCCH-ToReleaseList). For another example, a MAC-CE activation command (for a control channel) for a TCI state of a CORESET with a smallest index in an active BWP for the NCR-MT (in the PCell or PSCell). For another example, a physical downlink control channel TCI state parameter (for example, tci-StatesPDCCH-ToAddList and/or tci-StatesPDCCH-ToReleaseList) for the CORESET with the smallest index in the active BWP for the NCR-MT (in the PCell or PSCell).

After the NCR-MT receives the above spatial domain indication or the NCR-MT applies the above spatial domain indication, the NCR-Fwd determines/uses a spatial domain filter associated with a quasi co-location hypothesis (or a TCI state) of a CORESET with a smallest index in an active BWP of the NCR-MT for/to perform downlink reception.

Optionally, before the NCR-MT detects a downlink control channel (for example, corresponding to a downlink control information format with CRC scrambled by a C-RNTI or MCS-C-RNTI) in the search space (for example, the search space configured by the recovery search space parameter), the NCR-Fwd determines/uses a spatial domain filter associated with a quasi co-location hypothesis (or a TCI state) of a CORESET with a smallest index in an active BWP of the NCR-MT for/to perform downlink reception.

Optionally, in the method, a condition for performing the above NCR-Fwd behavior is that the NCR-MT does not support a second spatial domain indication (or has no capability of receiving the second spatial domain indication). The description of the second spatial domain indication refers to Method 3.

### Method 3

(For a PCell or PSCell,) after a predefined time (for example, 28 symbols) from PDCCH reception (for example, a last symbol for the PDCCH reception) of the NCR-MT in a search space (for example, a search space configured by a recovery search space parameter, for another example, a search space for the NCR-MT to detect a downlink control information format with CRC scrambled by a C-RNTI or MCS-C-RNTI) or a time reported based on an NCR-MT capability, until the NCR-MT receives a spatial domain indication or until the NCR-MT applies the spatial domain indication (or before the spatial domain indication), the NCR-Fwd determines/uses a spatial domain filter associated with an index q_{new} (or an antenna port quasi co-location parameter) for/to perform downlink reception.

The above spatial domain indication is a second spatial domain indication for the NCR-Fwd (backhaul link) (or a TCI state indication for the NCR-Fwd backhaul link; or MAC-CE signaling for the NCR-Fwd backhaul link; or a MAC-CE for carrying side control information). For example, a TCI state MAC-CE activation command for the NCR-Fwd backhaul link. Optionally, the NCR-MT also receives TCI state parameters (for example, TCI state lists, tci-StatesToAddModList and/or tci-StatesToReleaseList) (on a PCell or PSCell), and the MAC-CE signaling indicates/activates a TCI state/TCI state ID in the TCI state parameters.

After the NCR-MT receives the above spatial domain indication or the NCR applies the above spatial domain indication, the NCR-Fwd determines/uses a spatial domain filter associated with a TCI state indicated in the above spatial domain indication for/to perform downlink reception.

Optionally, before the NCR-MT detects a downlink control channel (for example, corresponding to a downlink control information format with CRC scrambled by a C-RNTI or MCS-C-RNTI) in the search space (for example, the search space configured by the recovery search space parameter), the NCR-Fwd determines/uses a spatial domain filter associated with a TCI state indicated in a previous spatial domain indication (for example, a spatial domain indication before the above spatial domain indication, and for another example, a previous spatial domain indication of the above spatial domain indication) for/to perform downlink reception.

Optionally, in the method, a condition for performing the above NCR-Fwd behavior is that the NCR-MT supports the second spatial domain indication (or has a capability of receiving the second spatial domain indication).

### Method 4

(For a PCell or PSCell,) after a predefined time (for example, 28 symbols) from PDCCH reception (for example, a last symbol for the PDCCH reception) of the NCR-MT in a search space (for example, a search space configured by a recovery search space parameter, for another example, a search space for the NCR-MT to detect a downlink control information format with CRC scrambled by a C-RNTI or MCS-C-RNTI) or a time reported based on an NCR-MT capability, until the NCR-MT receives a spatial domain indication or until the NCR-MT applies the spatial domain indication (or before the spatial domain indication), the NCR-Fwd determines/uses a spatial domain filter associated with an index q_{new} (or an antenna port quasi co-location parameter) for/to perform downlink reception.

The above spatial domain indication is a first spatial domain indication (Method 2) or a second spatial domain indication (Method 3). Optionally, it is an earlier indication of the first spatial domain indication or the second spatial domain indication.

When the above spatial domain indication is the first spatial domain indication (and the NCR-MT does not receive the second spatial domain indication), after the NCR-MT receives the above spatial domain indication or the NCR applies the above spatial domain indication, the NCR-Fwd determines/uses a spatial domain filter associated with a quasi co-location hypothesis (or a TCI state) of a CORESET with a smallest index in an active BWP of the NCR-MT for/to perform downlink reception.

When the above spatial domain indication is the second spatial domain indication, after the NCR-MT receives the above spatial domain indication or the NCR-MT applies the above spatial domain indication, the NCR-Fwd determines/uses a spatial domain filter associated with a TCI state indicated in the above spatial domain indication for/to perform downlink reception.

Optionally, before the NCR-MT detects a downlink control channel (for example, corresponding to a downlink control information format with CRC scrambled by a C-RNTI or MCS-C-RNTI) in the search space (for example, the search space configured by the recovery search space parameter), the NCR-Fwd determines/uses a spatial domain filter associated with a quasi co-location hypothesis (or a TCI state) of a CORESET with a smallest index in an active BWP of the NCR-MT for/to perform downlink reception.

Optionally, before the NCR-MT detects a downlink control channel (for example, corresponding to a downlink control information format with CRC scrambled by a C-RNTI or MCS-C-RNTI) in the search space (for example, the search space configured by the recovery search space parameter), the NCR-Fwd determines/uses a spatial domain filter associated with a TCI state indicated in a previous spatial domain indication (for example, a spatial domain indication before the above spatial domain indication, and for another example, a previous spatial domain indication of the above spatial domain indication) for/to perform downlink reception.

Optionally, in the method, a condition for performing the above NCR-Fwd behavior is that the NCR-MT supports the second spatial domain indication (or has a capability of receiving the second spatial domain indication). The description of the second spatial domain indication refers to Method 3.

At least one of the following methods is used to determine the behavior of the NCR-Fwd (uplink forwarding):

### Method 1

(For a PCell or PSCell,) after a predefined time (for example, 28 symbols) from PDCCH reception (for example, a last symbol for the PDCCH reception) of the NCR-MT in a search space (for example, a search space configured by a recovery search space parameter, for another example, a search space for the NCR-MT to detect a downlink control information format with CRC scrambled by a C-RNTI or MCS-C-RNTI) or a time reported based on an NCR-MT capability, the NCR-Fwd uses a same spatial domain filter as a last PRACH transmission of the NCR-MT for/to perform uplink forwarding.

Optionally, before the NCR-MT detects a downlink control channel (for example, corresponding to a downlink control information format with CRC scrambled by a C-RNTI or MCS-C-RNTI) in the search space (for example, the search space configured by the recovery search space parameter), the NCR-Fwd determines/uses a spatial domain filter associated with a spatial relation for (specific) PUCCH resources with a smallest index in an active BWP for the NCR-MT (in a PCell or PSCell) for/to perform uplink forwarding.

### Method 2

(For a PCell or PSCell,) after a predefined time (for example, 28 symbols) from PDCCH reception (for example, a last symbol for the PDCCH reception) of the NCR-MT in a search space (for example, a search space configured by a recovery search space parameter, for another example, a search space for the NCR-MT to detect a downlink control information format with CRC scrambled by a C-RNTI or MCS-C-RNTI) or a time reported based on an NCR-MT capability, until the NCR-MT receives a spatial domain indication or until the NCR-MT applies the spatial domain indication (or before the spatial domain indication), the NCR-Fwd uses a same spatial domain filter as a last PRACH transmission of the NCR-MT for/to perform uplink forwarding.

The above spatial domain indication is a first spatial domain indication (or spatial domain update indication) for (signals or channels of) the NCR-MT. Examples are as follows:
for example, the first spatial domain indication refers to a MAC-CE activation command for a spatial relation (for a physical uplink control channel). Optionally, the NCR-MT also receives a spatial relation parameter of the physical uplink control channel (for example, PUCCH-SpatialRelationInfo); the parameter includes multiple values. The MAC-CE activation command for the spatial relation of the physical uplink control channel acts on the spatial relation parameter of the physical uplink control channel (that is, a value of the spatial relation parameter activating the physical uplink control channel).

for another example, a MAC-CE activation command for a spatial relation for (specific) PUCCH resources with a smallest index in an active BWP for the NCR-MT (in a PCell or PSCell).

for another example, the first spatial domain indication refers to a spatial relation parameter for the physical uplink control channel of the NCR-MT (for example, PUCCH-SpatialRelationInfo). Optionally, the spatial relation parameter is a value (that is, indicating a spatial relation).

After the NCR-MT receives the above spatial domain indication or the NCR applies the above spatial domain indication, the NCR-Fwd determines/uses a spatial domain filter associated with a spatial relation for (specific) PUCCH resources with a smallest index in an active BWP for the NCR-MT (in a PCell or PSCell) for/to perform uplink forwarding.

Optionally, before the NCR-MT detects a downlink control channel (for example, corresponding to a downlink control information format with CRC scrambled by a C-RNTI or MCS-C-RNTI) in the search space (for example, the search space configured by the recovery search space parameter), the NCR-Fwd determines/uses a spatial domain filter associated with a spatial relation for (specific) PUCCH resources with a smallest index in an active BWP for the NCR-MT (in a PCell or PSCell) for/to perform uplink forwarding.

Optionally, in the method, a condition for performing the above NCR-Fwd behavior is that the NCR-MT does not support a second spatial domain indication (or has no capability of receiving the second spatial domain indication). The description of the second spatial domain indication refers to Method 3.

### Method 3

(For a PCell or PSCell,) after a predefined time (for example, 28 symbols) from PDCCH reception (for example, a last symbol for the PDCCH reception) of the NCR-MT in a search space (for example, a search space configured by a recovery search space parameter, for another example, a search space for the NCR-MT to detect a downlink control information format with CRC scrambled by a C-RNTI or MCS-C-RNTI) or a time reported based on an NCR-MT capability, until the NCR-MT receives the spatial domain indication or until the NCR-MT applies the spatial domain indication (or before the spatial domain indication), the NCR-Fwd uses a same spatial domain filter as a last PRACH transmission of the NCR-MT for/to perform uplink forwarding.

The above spatial domain indication is a second spatial domain indication for the NCR-Fwd (backhaul link) (or an SRS resource indicator (SRI) indication for the NCR-Fwd backhaul link; or MAC-CE signaling for the NCR-Fwd backhaul link; or a MAC-CE for carrying side control information). For example, a MAC-CE activation command for the SRI for the NCR-Fwd backhaul link. Optionally, the NCR-MT also receives SRS resource parameters (on a PCell or PSCell), and the MAC-CE signaling indicates/activates an SRS resource ID in the SRS resource parameters.

After the NCR-MT receives the above spatial domain indication or the NCR applies the above spatial domain indication, the NCR-Fwd determines/uses a spatial domain filter associated with an SRI indicated in the above spatial domain indication for/to perform uplink forwarding.

Optionally, before the NCR-MT detects a downlink control channel (for example, corresponding to a downlink control information format with CRC scrambled by a C-RNTI or MCS-C-RNTI) in the search space (for example, the search space configured by the recovery search space parameter), the NCR-Fwd determines/uses a spatial domain filter associated with an SRI indicated in a previous spatial domain indication (for example, a spatial domain indication before the above spatial domain indication, and for another example, a previous spatial domain indication of the above spatial domain indication) for/to perform downlink reception.

Optionally, in the method, a condition for performing the above NCR-Fwd behavior is that the NCR-MT supports the second spatial domain indication (or has a capability of receiving the second spatial domain indication).

### Method 4

(For a PCell or PSCell,) after a predefined time (for example, 28 symbols) from PDCCH reception (for example, a last symbol for the PDCCH reception) of the NCR-MT in a search space (for example, a search space configured by a recovery search space parameter, for another example, a search space for the NCR-MT to detect a downlink control information format with CRC scrambled by a C-RNTI or MCS-C-RNTI) or a time reported based on an NCR-MT capability, until the NCR-MT receives the spatial domain indication or until the NCR-MT applies the spatial domain indication (or before the spatial domain indication), the NCR-Fwd transmits a PUCCH using a same spatial domain filter as a last PRACH transmission of the NCR-MT.

The above spatial domain indication is a first spatial domain indication (Method 2) or a second spatial domain indication (Method 3). Optionally, it is an earlier indication of the first spatial domain indication or the second spatial domain indication.

When the spatial domain indication is the first spatial domain indication (and the NCR-MT does not receive the second spatial domain indication), after the NCR-MT receives the above spatial domain indication or the NCR applies the above spatial domain indication, the NCR-Fwd determines/uses a spatial domain filter associated with a spatial relation for (specific) PUCCH resources with a smallest index in an active BWP for the NCR-MT (in a PCell or PSCell) for/to perform uplink forwarding.

When the spatial domain indication is the second spatial domain indication, after the NCR-MT receives the above spatial domain indication or the NCR applies the above spatial domain indication, the NCR-Fwd determines/uses a spatial domain filter associated with an SRI indicated in the above spatial domain indication for/to perform uplink forwarding.

Optionally, before the NCR-MT detects a downlink control channel (for example, corresponding to a downlink control information format with CRC scrambled by a C-RNTI or MCS-C-RNTI) in the search space (for example, the search space configured by the recovery search space parameter), the NCR-Fwd determines/uses a spatial domain filter associated with a spatial relation for (specific) PUCCH resources with a smallest index in an active BWP for the NCR-MT (in a PCell or PSCell) for/to perform uplink forwarding.

Optionally, before the NCR-MT detects a downlink control channel (for example, corresponding to a downlink control information format with CRC scrambled by a C-RNTI or MCS-C-RNTI) in the search space (for example, the search space configured by the recovery search space parameter), the NCR-Fwd determines/uses a spatial domain filter associated with an SRI indicated in a previous spatial domain indication (for example, a spatial domain indication before the above spatial domain indication, and for another example, a previous spatial domain indication of the above spatial domain indication) for/to perform downlink reception.

Optionally, in the method, a condition for performing the above NCR-Fwd behavior is that the NCR-MT supports the second spatial domain indication (or has a capability of receiving the second spatial domain indication). The description of the second spatial domain indication refers to Method 3.

This example describes the behavior of the NCR-Fwd after a predefined time from the NCR-MT receives the beam failure recovery response. When a unit of this predefined time is a slot or symbol, because the NCR may obtain different subcarrier spacing configurations, a subcarrier spacing (configuration) of the predefined time needs to be determined. The method for determining the subcarrier spacing (configuration) of the predefined time is at least one of:

### Method (1)

The subcarrier spacing (configuration) of the predefined time refers to a subcarrier spacing (configuration) of an active downlink BWP in which the beam failure recovery response is received.

### Method (2)

The subcarrier spacing (configuration) of the predefined time refers to a subcarrier spacing (configuration) for the NCR-Fwd. Optionally, the subcarrier spacing (configuration) of the predefined time refers to a smallest/largest subcarrier spacing (configuration) among the subcarrier spacings (configurations) for the NCR-Fwd. For example, when the NCR receives one or more subcarrier spacing indication (or configuration information) information for indicating time resources used by the NCR-Fwd for forwarding (or for beam indication), the subcarrier spacing (configuration) of the predefined time refers to a smallest/largest subcarrier spacing (configuration) in the one or more indications (or configuration information).

### Method (3)

The subcarrier spacing (configuration) of the predefined time refers to a smallest/largest subcarrier spacing (configuration) among the subcarrier spacing (configuration) described in method (1) and the subcarrier spacing (configuration) described in method (2).

This example describes the behavior of the NCR-Fwd after a predefined time from the NCR-MT receives the beam failure recovery response. Optionally, the behavior of the NCR-Fwd is applicable to time resources without simultaneous downlink reception or uplink transmission in (a control link of) the NCR-MT and a backhaul link of the NCR-Fwd (occurring/being performed). In other words, on a time resource, if no downlink reception or uplink transmission occurs/is performed simultaneously in (the control link of) the NCR-MT and the backhaul link of the NCR-Fwd, and after a predefined time from the NCR-MT receiving the beam failure recovery response, the NCR-Fwd applies the behavior described in this example on the corresponding resources. In other words, after a predefined time from the NCR-MT receiving the beam failure recovery response, and when no downlink reception or uplink transmission occurs/is performed simultaneously in (the control link of) the NCR-MT and (the backhaul link of) the NCR-Fwd, the NCR-Fwd performs the behavior described in this example.

Optionally, on a time resource (regardless of whether the NCR-MT has the above beam failure recovery behavior, or the above beam failure recovery behavior occurs; the beam failure recovery behavior is, for example, that (after) the NCR-MT receives the beam failure recovery response and/or (until) the NCR-MT receives the spatial domain indication), when downlink reception or uplink transmission occurs/is performed simultaneously in (the control link of) the NCR-MT and the backhaul link of the NCR-Fwd, the spatial domain filter (or the beam/antenna port quasi co-location parameter) used by the NCR-Fwd is determined according to the spatial domain filter (or the beam/antenna port quasi co-location parameter) used by the NCR-MT. Optionally, the NCR-Fwd uses a same spatial domain filter as used by the NCR-MT for downlink reception or uplink forwarding.

In the disclosure, on a time resource, no downlink reception or uplink transmission occurring/being performed simultaneously in (the control link of) the NCR-MT and (the backhaul link of) the NCR-Fwd may be understood as: 1) a first time resource in which the NCR-MT receives downlink signals or downlink channels not overlapping with a second time resource in which the NCR-Fwd performs downlink reception on a time resource; and/or, 2) a third time resource in which the NCR-MT transmits uplink signals or downlink channels not overlapping with a fourth time resource in which the NCR-Fwd performs uplink forwarding on a time resource.

In the disclosure, on a time resource, downlink reception or uplink transmission occurring/being performed simultaneously in (the control link of) the NCR-MT and (the backhaul link of) the NCR-Fwd may be understood as: 1) a first time resource in which the NCR-MT receives downlink signals or downlink channels overlapping with a second time resource in which the NCR-Fwd performs downlink reception on a time resource; and/or, 2) a third time resource in which the NCR-MT transmits uplink signals or uplink channels overlapping with a fourth time resource in which the NCR-Fwd performs uplink forwarding on a time resource.

This example describes the behavior of the NCR in the case that the NCR performs the beam failure recovery procedure. These methods can recover the communication between the NCR and the network device when the NCR has beam failures, which improves the reliability of the communication system.

### EXAMPLE 2

In this example, a behavior of the NCR-Fwd is described by way of example in which the NCR-MT is configured with a Rel-17 beam management framework. The NCR-MT being configured with the Rel-17 beam management framework means/may be understood as at least one of:
the NCR-MT being provided/configured with a downlink or joint TCI state list parameter (for example, dl-OrJoint-TCIStateList or dl-OrJoint-TCIStateList-r17);
the NCR-MT being provided/configured with an uplink TCI state parameter (for example, UL-TCIstate);
the NCR-MT being provided/configured with a downlink or joint TCI state list parameter (for example, dl-OrJoint-TCIStateList or dl-OrJoint-TCIStateList-r17) for indicating a unified TCI state (for PCell or PSCell);
the NCR-MT being provided/configured with an uplink TCI state parameter (for example, UL-TCIstate) for indicating the unified TCI state (for PCell or PSCell);
the NCR-MT being provided/configured with a TCI state parameter (for example, TCI-State_r17 or TCI-State) for indicating the unified TCI state (for PCell or PSCell).

An example in which the NCR-MT is provided/configured with the downlink or joint TCI state list parameter is described.

An example in which a beam failure recovery response is a PDCCH in a downlink control information format with CRC scrambled by a C-RNTI or MCS-C-RNTI is described. The beam failure recovery response may also be a PDCCH used to determine end of a contention-based random access procedure. Optionally, the NCR-MT is further provided with a beam failure recovery MAC-CE in Message 3(Msg3 ) or Message A (MsgA) of the contention-based random access procedure. The beam failure recovery response may also be other channels or signals, and the method is not limited thereto.

The NCR-MT can be configured with a configuration of up to 128 TCI states in the downlink or joint TCI state list parameter (for example, dl-OrJoint-TCIStateList) in a UE-specific PDSCH parameter (for example, PDSCH-config). The TCI states (configurations) or each TCI state (configuration):
is used to provide a demodulation reference signal of a PDCCH, a demodulation reference signal of a PDSCH and a quasi co-location reference signal of a CSI-RS of the NCR-MT, and/or
(if applicable) provides a reference for determining an uplink transmission spatial domain filter of PUSCH, PUCCH resources and SRS based on dynamic grant and configured grant of the NCR-MT.

The NCR-MT can be configured with a configuration of up to 64 uplink TCI states in a dedicated UE-specific uplink BWP parameter (for example, BWP-UplinkDedicated). The uplink TCI states (configurations) or each uplink TCI state (configuration) includes a parameter for configuring a reference signal (if applicable) to determine the uplink transmission spatial domain filter of PUSCH, PUCCH resources and SRS based on dynamic grant and configured grant of the NCR-MT.

Optionally, the NCR-MT is provided/configured with the downlink or joint TCI state list parameter (and/or uplink TCI state).

At least one of the following methods is used to determine the behavior of the NCR-Fwd (downlink reception):

### Method 1

(For a PCell or PSCell,) after a predefined time (for example, 28 symbols) from PDCCH reception (for example, a last symbol for the PDCCH reception) of the NCR-MT in a search space (for example, a search space configured by a recovery search space parameter, for another example, a search space for the NCR-MT to detect a downlink control information format with CRC scrambled by a C-RNTI or MCS-C-RNTI) or a time reported based on an NCR-MT capability, the NCR-Fwd determines/uses a spatial domain filter associated with an index q_{new} (or an antenna port quasi co-location parameter) for/to perform downlink reception.

Optionally, before the NCR-MT detects a downlink control channel (for example, corresponding to a downlink control information format with CRC scrambled by a C-RNTI or MCS-C-RNTI) in the search space (for example, the search space configured by the recovery search space parameter), the NCR-Fwd determines/uses a spatial domain filter associated with a TCI state indicated in a spatial domain indication for/to perform downlink reception.

The above spatial domain indication is a first spatial domain indication (or spatial domain update indication) for (signals or channels of) the NCR-MT. For example, a (unified/joint) TCI state indication. The NCR-MT is indicated with a TCI state; the TCI state is from a downlink or joint TCI state list parameter (for example, dl-OrJoint-TCIStateList or dl-OrJoint-TCIStateList-r17). Optionally, the indication is indicated by at least one of DCI, MAC-CE and RRC.

### Method 2

(For a PCell or PSCell,) after a predefined time (for example, 28 symbols) from PDCCH reception (for example, a last symbol for the PDCCH reception) of the NCR-MT in a search space (for example, a search space configured by a recovery search space parameter, for another example, a search space for the NCR-MT to detect a downlink control information format with CRC scrambled by a C-RNTI or MCS-C-RNTI) or a time reported based on an NCR-MT capability, until the NCR-MT receives a spatial domain indication or until the NCR-MT applies the spatial domain indication (or before the spatial domain indication), the NCR-Fwd determines/uses a spatial domain filter associated with an index q_{new} (or an antenna port quasi co-location parameter) for/to perform downlink reception.

The above spatial domain indication is a first spatial domain indication (or spatial domain update indication) for (signals or channels of) the NCR-MT. For example, a (unified/joint) TCI state indication. The NCR-MT is indicated with a TCI state; the TCI state is from a downlink or joint TCI state list parameter (for example, dl-OrJoint-TCIStateList or dl-OrJoint-TCIStateList-r17). Optionally, the indication is indicated by at least one of DCI, MAC-CE and RRC.

After the NCR-MT receives the above spatial domain indication or the NCR-MT applies the above spatial domain indication, the NCR-Fwd determines/uses a spatial domain filter associated with a TCI state indicated in the above spatial domain indication for/to perform downlink reception.

Optionally, before the NCR-MT detects a downlink control channel (for example, corresponding to a downlink control information format with CRC scrambled by a C-RNTI or MCS-C-RNTI) in the search space (for example, the search space configured by the recovery search space parameter), the NCR-Fwd determines/uses a spatial domain filter associated with a TCI state indicated in a previous spatial domain indication (for example, a spatial domain indication before the above spatial domain indication, and for another example, a previous spatial domain indication of the above spatial domain indication) for/to perform downlink reception.

Optionally, in the method, a condition for performing the above NCR-Fwd behavior is that the NCR-MT does not support a second spatial domain indication (or has no capability of receiving the second spatial domain indication). The description of the second spatial domain indication refers to Method 3.

### Method 3

(For a PCell or PSCell,) after a predefined time (for example, 28 symbols) from PDCCH reception (for example, a last symbol for the PDCCH reception) of the NCR-MT in a search space (for example, a search space configured by a recovery search space parameter, for another example, a search space for the NCR-MT to detect a downlink control information format with CRC scrambled by a C-RNTI or MCS-C-RNTI) or a time reported based on an NCR-MT capability, until the NCR-MT receives a spatial domain indication or until the NCR-MT applies the spatial domain indication (or before the spatial domain indication), the NCR-Fwd determines/uses a spatial domain filter associated with an index q_{new} (or an antenna port quasi co-location parameter) for/to perform downlink reception.

The above spatial domain indication is a second spatial domain indication for the NCR-Fwd (backhaul link) (or a TCI state indication for the NCR-Fwd backhaul link; or MAC-CE signaling for the NCR-Fwd backhaul link; or a MAC-CE for carrying side control information). For example, a TCI state MAC-CE activation command for the NCR-Fwd backhaul link. Optionally, the NCR-MT also receives a TCI state parameter (for example, a downlink or joint TCI state list parameter, for example, dl-OrJoint-TCIStateList or dl-OrJoint-TCIStateList-r17) (on the PCell or PSCell), and the MAC-CE signaling indicates/activates a TCI state/TCI state ID in the TCI state parameters.

After the NCR-MT receives the above spatial domain indication or the NCR applies the above spatial domain indication, the NCR-Fwd determines/uses a spatial domain filter associated with a TCI state indicated in the above spatial domain indication for/to perform downlink reception.

Optionally, before the NCR-MT detects a downlink control channel (for example, corresponding to a downlink control information format with CRC scrambled by a C-RNTI or MCS-C-RNTI) in the search space (for example, the search space configured by the recovery search space parameter), the NCR-Fwd determines/uses a spatial domain filter associated with a TCI state indicated in a previous spatial domain indication (for example, a spatial domain indication before the above spatial domain indication, and for another example, a previous spatial domain indication of the above spatial domain indication) for/to perform downlink reception.

Optionally, in the method, a condition for performing the above NCR-Fwd behavior is that the NCR-MT supports the second spatial domain indication (or has a capability of receiving the second spatial domain indication).

### Method 4

(For a PCell or PSCell,) after a predefined time (for example, 28 symbols) from PDCCH reception (for example, a last symbol for the PDCCH reception) of the NCR-MT in a search space (for example, a search space configured by a recovery search space parameter, for another example, a search space for the NCR-MT to detect a downlink control information format with CRC scrambled by a C-RNTI or MCS-C-RNTI) or a time reported based on an NCR-MT capability, until the NCR-MT receives a spatial domain indication or until the NCR-MT applies the spatial domain indication (or before the spatial domain indication), the NCR-Fwd determines/uses a spatial domain filter associated with an index q_{new} (or an antenna port quasi co-location parameter) for/to perform downlink reception.

The above spatial domain indication is a first spatial domain indication (Method 2) or a second spatial domain indication (Method 3). Optionally, it is an earlier indication of the first spatial domain indication or the second spatial domain indication.

When the above spatial domain indication is the first spatial domain indication (and the NCR-MT does not receive the second spatial domain indication), after the NCR-MT receives the above spatial domain indication or the NCR applies the above spatial domain indication, the NCR-Fwd determines/uses a spatial domain filter associated with a TCI state indicated in the above spatial domain indication for/to perform downlink reception.

When the above spatial domain indication is the second spatial domain indication, after the NCR-MT receives the above spatial domain indication or the NCR applies the above spatial domain indication, the NCR-Fwd determines/uses a spatial domain filter associated with a TCI state indicated in the above spatial domain indication for/to perform downlink reception.

Optionally, before the NCR-MT detects a downlink control channel (for example, corresponding to a downlink control information format with CRC scrambled by a C-RNTI or MCS-C-RNTI) in the search space (for example, the search space configured by the recovery search space parameter), the NCR-Fwd determines/uses a spatial domain filter associated with a TCI state indicated in a previous spatial domain indication (for example, a spatial domain indication before the above spatial domain indication, and for another example, a previous spatial domain indication of the above spatial domain indication) for/to perform downlink reception.

Optionally, in the method, a condition for performing the above NCR-Fwd behavior is that the NCR-MT supports the second spatial domain indication (or has a capability of receiving the second spatial domain indication). The description of the second spatial domain indication refers to Method 3.

At least one of the following methods is used to determine the behavior of the NCR-Fwd (uplink forwarding):

### Method 1

(For a PCell or PSCell,) after a predefined time (for example, 28 symbols) from PDCCH reception (for example, a last symbol for the PDCCH reception) of the NCR-MT in a search space (for example, a search space configured by a recovery search space parameter, for another example, a search space for the NCR-MT to detect a downlink control information format with CRC scrambled by a C-RNTI or MCS-C-RNTI) or a time reported based on an NCR-MT capability:
the NCR-Fwd uses a same spatial domain filter as a last PRACH transmission of the NCR-MT for/to perform uplink forwarding; or,
the NCR-Fwd uses a spatial domain filter associated with an index q_{new} for/to perform uplink forwarding.

Optionally, before the NCR-MT detects a downlink control channel (for example, corresponding to a downlink control information format with CRC scrambled by a C-RNTI or MCS-C-RNTI) in the search space (for example, the search space configured by the recovery search space parameter), the NCR-Fwd determines/uses a spatial domain filter associated with a TCI state indicated in a spatial domain indication for/to perform downlink reception.

The above spatial domain indication is a first spatial domain indication (or spatial domain update indication) for (signals or channels of) the NCR-MT. For example, a (unified/joint) TCI state indication. The NCR-MT is indicated with a TCI state; the TCI state is from a downlink or joint TCI state list parameter (for example, dl-OrJoint-TCIStateList or dl-OrJoint-TCIStateList-r17). For another example, an uplink TCI state indication. The NCR-MT is indicated with a TCI state; the TCI state is an uplink TCI state (for example, UL-TCIstate). Optionally, the indication is indicated by at least one of DCI, MAC-CE and RRC.

### Method 2

(For a PCell or PSCell,) after a predefined time (for example, 28 symbols) from PDCCH reception (for example, a last symbol for the PDCCH reception) of the NCR-MT in a search space (for example, a search space configured by a recovery search space parameter, for another example, a search space for the NCR-MT to detect a downlink control information format with CRC scrambled by a C-RNTI or MCS-C-RNTI) or a time reported based on an NCR-MT capability, until the NCR-MT receives a spatial domain indication or until the NCR-MT applies the spatial domain indication (or before the spatial domain indication):
the NCR-Fwd uses a same spatial domain filter as a last PRACH transmission of the NCR-MT for/to perform uplink forwarding; or,
the NCR-Fwd uses a spatial domain filter associated with an index q_{new} for/to perform uplink forwarding.

The above spatial domain indication is a first spatial domain indication (or spatial domain update indication) for (signals or channels of) the NCR-MT. For example, a (unified/joint) TCI state indication. The NCR-MT is indicated with a TCI state; the TCI state is from a downlink or joint TCI state list parameter (for example, dl-OrJoint-TCIStateList or dl-OrJoint-TCIStateList-r17). For another example, an uplink TCI state indication. The NCR-MT is indicated with a TCI state; the TCI state is an uplink TCI state (for example, UL-TCIstate). Optionally, the indication is indicated by at least one of DCI, MAC-CE and RRC.

After the NCR-MT receives the above spatial domain indication or the NCR-MT applies the above spatial domain indication, the NCR-Fwd determines/uses a spatial domain filter associated with a TCI state indicated in the above spatial domain indication for/to perform uplink forwarding.

Optionally, before the NCR-MT detects a downlink control channel (for example, corresponding to a downlink control information format with CRC scrambled by a C-RNTI or MCS-C-RNTI) in the search space (for example, the search space configured by the recovery search space parameter), the NCR-Fwd determines/uses a spatial domain filter associated with a TCI state indicated in a previous spatial domain indication (for example, a spatial domain indication before the above spatial domain indication, and for another example, a previous spatial domain indication of the above spatial domain indication) for/to perform uplink forwarding.

Optionally, in the method, a condition for performing the above NCR-Fwd behavior is that the NCR-MT does not support a second spatial domain indication (or has no capability of receiving the second spatial domain indication). The description of the second spatial domain indication refers to Method 3.

### Method 3

(For a PCell or PSCell,) after a predefined time (for example, 28 symbols) from PDCCH reception (for example, a last symbol for the PDCCH reception) of the NCR-MT in a search space (for example, a search space configured by a recovery search space parameter, for another example, a search space for the NCR-MT to detect a downlink control information format with CRC scrambled by a C-RNTI or MCS-C-RNTI) or a time reported based on an NCR-MT capability, until the NCR-MT receives a spatial domain indication or until the NCR-MT applies the spatial domain indication (or before the spatial domain indication):
the NCR-Fwd uses a same spatial domain filter as a last PRACH transmission of the NCR-MT for/to perform uplink forwarding; or,
the NCR-Fwd uses a spatial domain filter associated with an index q_{new} for/to perform uplink forwarding.

The above spatial domain indication is a second spatial domain indication for the NCR-Fwd (backhaul link) (or a TCI state indication for the NCR-Fwd backhaul link; or MAC-CE signaling for the NCR-Fwd backhaul link; or a MAC-CE for carrying side control information). For example, a TCI state MAC-CE activation command for the NCR-Fwd backhaul link. Optionally, the NCR-MT also receives a TCI state parameter (for example, a downlink or joint TCI state list parameter, for example, dl-OrJoint-TCIStateList or dl-OrJoint-TCIStateList-r17, for another example, an uplink TCI state parameter, for another example, UL-TCIstate) (on the PCell or PSCell), and the MAC-CE signaling indicates/activates a TCI state/TCI state ID in the TCI state parameters.

After the NCR-MT receives the above spatial domain indication or the NCR applies the above spatial domain indication, the NCR-Fwd determines/uses a spatial domain filter associated with a TCI state indicated in the above spatial domain indication for/to perform uplink forwarding.

Optionally, before the NCR-MT detects a downlink control channel (for example, corresponding to a downlink control information format with CRC scrambled by a C-RNTI or MCS-C-RNTI) in the search space (for example, the search space configured by the recovery search space parameter), the NCR-Fwd determines/uses a spatial domain filter associated with an SRI indicated in a previous spatial domain indication (for example, a spatial domain indication before the above spatial domain indication, and for another example, a previous spatial domain indication of the above spatial domain indication) for/to perform downlink reception.

Optionally, in the method, a condition for performing the above NCR-Fwd behavior is that the NCR-MT supports the second spatial domain indication (or has a capability of receiving the second spatial domain indication).

### Method 4

(For a PCell or PSCell,) after a predefined time (for example, 28 symbols) from PDCCH reception (for example, a last symbol for the PDCCH reception) of the NCR-MT in a search space (for example, a search space configured by a recovery search space parameter, for another example, a search space for the NCR-MT to detect a downlink control information format with CRC scrambled by a C-RNTI or MCS-C-RNTI) or a time reported based on an NCR-MT capability, until the NCR-MT receives a spatial domain indication or until the NCR-MT applies the spatial domain indication (or before the spatial domain indication):
the NCR-Fwd uses a same spatial domain filter as a last PRACH transmission of the NCR-MT for/to perform uplink forwarding; or,
the NCR-Fwd uses a spatial domain filter associated with an index q_{new} for/to perform uplink forwarding.

The above spatial domain indication is a first spatial domain indication (Method 2) or a second spatial domain indication (Method 3). Optionally, it is an earlier indication of the first spatial domain indication or the second spatial domain indication.

When the above spatial domain indication is the first spatial domain indication (and the NCR-MT does not receive the second spatial domain indication), after the NCR-MT receives the above spatial domain indication or the NCR applies the above spatial domain indication, the NCR-Fwd determines/uses a spatial domain filter associated with a TCI state indicated in the above spatial domain indication for/to perform uplink forwarding.

When the above spatial domain indication is the second spatial domain indication, after the NCR-MT receives the above spatial domain indication or the NCR applies the above spatial domain indication, the NCR-Fwd determines/uses a spatial domain filter associated with a TCI state indicated in the above spatial domain indication for/to perform uplink forwarding.

Optionally, before the NCR-MT detects a downlink control channel (for example, corresponding to a downlink control information format with CRC scrambled by a C-RNTI or MCS-C-RNTI) in the search space (for example, the search space configured by the recovery search space parameter), the NCR-Fwd determines/uses a spatial domain filter associated with a TCI state indicated in a previous spatial domain indication (for example, a spatial domain indication before the above spatial domain indication, and for another example, a previous spatial domain indication of the above spatial domain indication) for/to perform uplink forwarding.

Optionally, in the method, a condition for performing the above NCR-Fwd behavior is that the NCR-MT supports the second spatial domain indication (or has a capability of receiving the second spatial domain indication). The description of the second spatial domain indication refers to Method 3.

This example describes the behavior of the NCR-Fwd after a predefined time from the NCR-MT receives the beam failure recovery response. When a unit of this predefined time is a slot or symbol, because the NCR may obtain different subcarrier spacing configurations, a subcarrier spacing (configuration) of the predefined time needs to be determined. The method for determining the subcarrier spacing (configuration) of the predefined time is at least one of:

### Method (1)

The subcarrier spacing (configuration) of the predefined time refers to a subcarrier spacing (configuration) of an active downlink BWP in which the beam failure recovery response is received

### Method (2)

The subcarrier spacing (configuration) of the predefined time refers to a subcarrier spacing (configuration) for the NCR-Fwd. Optionally, the subcarrier spacing (configuration) of the predefined time refers to a smallest/largest subcarrier spacing (configuration) among the subcarrier spacings (configurations) for the NCR-Fwd. For example, when the NCR receives one or more subcarrier spacing indications (or configuration information) for indicating time resources used by the NCR-Fwd for forwarding (or for beam indication), the subcarrier spacing (configuration) of the predefined time refers to a smallest/largest subcarrier spacing (configuration) in the one or more indications (or configuration information).

### Method (3)

The subcarrier spacing (configuration) of the predefined time refers to a smallest/largest subcarrier spacing (configuration) among the subcarrier spacing (configuration) described in method (1) and the subcarrier spacing (configuration) described in method (2).

This example describes the behavior of the NCR-Fwd after the NCR-MT receives the beam failure recovery response. Optionally, the behavior of the NCR-Fwd is applicable to time resources without simultaneous downlink reception or uplink transmission in (a control link of) the NCR-MT and the NCR-Fwd backhaul link (occurring/being performed). In other words, on a time resource, if no downlink reception or uplink transmission occurs/is performed simultaneously in (the control link of) the NCR-MT and (the backhaul link of) the NCR-Fwd, and after a predefined time from the NCR-MT receiving the beam failure recovery response, the NCR-Fwd applies the behavior described in this example on the corresponding resources. In other words, after a predefined time from the NCR-MT receiving the beam failure recovery response, and when no downlink reception or uplink transmission occurs/is performed simultaneously in (the control link of) the NCR-MT and (the backhaul link of) the NCR-Fwd, the NCR-Fwd performs the behavior described in this example. Optionally, on a time resource (regardless of whether the NCR-MT has the above beam failure recovery behavior, or the above beam failure recovery behavior occurs; the beam failure recovery behavior is, for example, that (after) the NCR-MT receives the beam failure recovery response and/or (until) the NCR-MT receives the spatial domain indication), when downlink reception or uplink transmission occurs/is performed simultaneously in (the control link of) the NCR-MT and (the backhaul link of) the NCR-Fwd, the spatial domain filter (or the beam/antenna port quasi co-location parameter) used by the NCR-Fwd is determined according to the spatial domain filter (or the beam/antenna port quasi co-location parameter) used by the NCR-MT. Optionally, the NCR-Fwd uses a same spatial domain filter as used by the NCR-MT for downlink reception or uplink forwarding.

This example describes the behavior of the NCR in the case that the NCR performs the beam failure recovery procedure. This method can recover the communication between the NCR and the network device when the NCR has beam failures, which improves the reliability of the communication system.

FIG. 6 illustrates a flowchart of a method 600 performed by a network device according to various embodiments of the disclosure. The method 600 includes, at 610, transmitting a beam failure recovery response to a repeater; at 620, performing downlink transmission and/or uplink reception, wherein the beam failure recovery response is used for a forwarder (NCR-Fwd) in the repeater to perform at least one of the following operations: using a spatial domain filter associated with an index q_{new} for downlink reception and/or uplink forwarding; using a spatial domain filter used in a last physical random access channel (PRACH) transmission of an NCR-MT for the uplink forwarding.

FIG. 7 illustrates a structure 700 of a repeater according to various embodiments of the disclosure. As shown in FIG. 7, the repeater 700 includes a controller 710 and a transceiver 720, wherein the controller 710 is configured to perform the above various methods disclosed herein that are performed by the repeater, and the transceiver 720 is configured to transceive channels or signals.

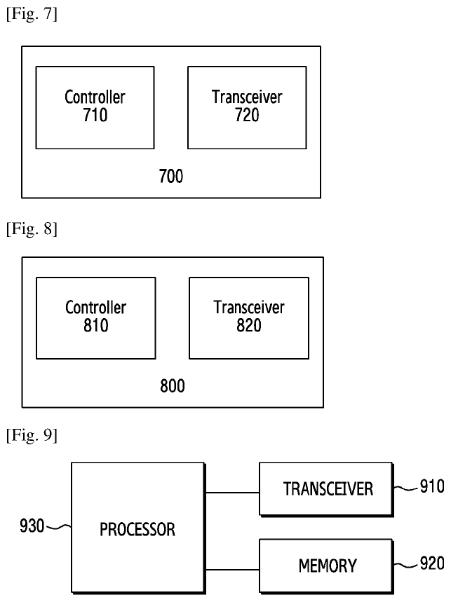

FIG. 8 illustrates a structure 800 of a network device according to various embodiments of the disclosure. As shown in FIG. 8, the network device 800 includes a controller 810 and a transceiver 820, wherein the controller 810 is configured to perform the above various methods disclosed herein that are performed by the network device, and the transceiver 820 is configured to transceive channels or signals.

FIG. 9 illustrates a structure of a device according to embodiments of the disclosure.

As shown in FIG. 9, the device according to an embodiment may include a transceiver 910, a memory 920, and a processor 930. The transceiver 910, the memory 920, and the processor 930 of the device may operate according to a communication method of the device described above. However, the components of the device are not limited thereto. For example, the device may include more or fewer components than those described above. In addition, the processor 930, the transceiver 910, and the memory 920 may be implemented as a single chip. Also, the processor 930 may include at least one processor. Furthermore, the device of FIG. 9 corresponds to the NCR, the base station or the user equipment in embodiments of other Figures described above.

The transceiver 910 collectively refers to a device receiver and a device transmitter, and may transmit/receive a signal to/from a terminal(UE) or a network entity. The signal transmitted or received to or from the terminal or a network entity may include control information and data. The transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the device. Also, the memory 920 may store control information or data included in a signal obtained by the device. The memory 920 may be a storage medium, such as read-only memory (ROM), random access memory (RAM), a hard disk, a CD-ROM, and a DVD, or a combination of storage media.

The processor 930 may control a series of processes such that the device operates as described above. For example, the transceiver 910 may receive a data signal including a control signal transmitted by the terminal, and the processor 930 may determine a result of receiving the control signal and the data signal transmitted by the terminal.

An NCR (for example, an NCR-MT) may receive multiple beam indications (for example, beam indications for an access link). Different beam indications may indicate corresponding time resources. When time resources corresponding to different beams indications are related (for example, the same or overlap), how to process accordingly (for example, what is a behavior of an NCR-Fwd) is a problem to be solved, otherwise the behavior of the NCR is unclear. The solution to the above problems is illustrated below by way of example.

### EXAMPLE 1

The NCR (for example, the NCR-MT) receives a first indication information and a second indication information; in which, the first indication information indicates first beam information (e.g., beam index) and corresponding/associated first time resource; or the first indication information indicates first time resource and corresponding/associated first beam information (e.g., beam index);
the second indication information indicates second beam information (e.g., beam index) and corresponding/associated second time resource; or the second indication information indicates second time resource and corresponding/associated second beam information (e.g., beam index);
if the first time resource overlaps with the second time resource (or the first time resource and the second time resource is the same), the NCR (for example, the NCR-Fwd) does not apply/use the second indication information or the first indication information; or the NCR (for example, the NCR-Fwd) applies/uses the first indication information or the second indication information; or the NCR (for example, the NCR-Fwd) applies/uses the first indication information or the second indication information in an overlapping part of the first time resource and the second time resource; or the NCR (for example, the NCR-Fwd) does not apply/use the first indication information or the second indication information in the overlapping part of the first time resource and the second time resource.

Optionally, if the first time resource overlaps with the second time resource (or the first time resource and the second time resource is the same), the NCR (for example, the NCR-Fwd) applying/using the first indication information or the second indication information; or the NCR (for example, the NCR-Fwd) applying/using the first indication information or the second indication information in the overlapping part of the first time resource and the second time resource, including:
if the first time resource overlaps with the second time resource (or the first time resource and the second time resource is the same), and the second time resource is not associated/configured with a priority indicator (for example, a semi-persistent forwarding resource (list/set) or a periodic forwarding resource (list/set) associated with the second time resource is not configured with the priority indicator), the NCR (for example, the NCR-Fwd) applies/uses the first indication information; or,
if the first time resource overlaps with the second time resource (or the first time resource and the second time resource is the same), and the second time resource is associated/configured with a priority indicator (for example, a semi-persistent forwarding resource (list/set) or a periodic forwarding resource (list/set) associated with the second time resource is configured with the priority indicator), the NCR (for example, the NCR-Fwd) applies/uses the second indication information; or,
if the first time resource overlaps with the second time resource (or the first time resource and the second time resource is the same), and the second time resource is not associated/configured with a priority indicator (for example, a semi-persistent forwarding resource (list/set) or a periodic forwarding resource (list/set) associated with the second time resource is not configured with the priority indicator), the NCR (for example, the NCR-Fwd) applies/uses the first indication information in the overlapping part of the first time resource and the second time resource; or,
if the first time resource overlaps with the second time resource (or the first time resource and the second time resource is the same), and the second time resource is associated/configured with a priority indicator (for example, a semi-persistent forwarding resource (list/set) or a periodic forwarding resource (list/set) associated with the second time resource is configured with the priority indicator), the NCR (for example, the NCR-Fwd) applies/uses the second indication information in the overlapping part of the first time resource and the second time resource.

Optionally, the overlapping part may be a set of symbols. Optionally, the overlapping part may be a set of slots. Optionally, a subcarrier spacing (SCS) of (associated with) the overlapping part is based on/refers to an SCS of the first time resource. Optionally, the subcarrier spacing (SCS) of (associated with) the overlapping part is based on/refers to an SCS of the second time resource. The advantage of the method is that the subcarrier spacing corresponding to the time unit of the overlapping part can be clarified, and the base station and the NCR can be avoided from having different understandings of the overlapping part.

Optionally, the priority indicator is used to determine a priority between a periodic beam indication or a semi-persistent beam indication and an aperiodic beam indication. For example, when the priority indicator is configured, time resources corresponding to/indicated by the periodic beam indication, or time resources corresponding to/indicated by the semi-persistent beam indication have a higher priority than time resources corresponding to/indicated by the aperiodic beam indication.

Optionally, the first indication information is dynamic indication information.

Optionally, the first indication information is carried by a DCI format. DCI format 5_0 or DCI format 2_8 is described as an example below. Optionally, the first indication information is carried by DCI format 5_0 or DCI format 2_8. In other words, the first indication information indicating the first beam information (e.g., beam index) and the corresponding/associated first time resource may be understood as DCI format 5_0 or DCI format 2_8 indicating the first beam information (e.g., beam index) and the corresponding/associated first time resource. For example, the time resources are associated with/correspond to aperiodic forwarding resources. For example, the aperiodic forwarding resources are configured by RRC signaling (AperiodicFwdResource).

Optionally, the second indication information is semi-persistent indication information or semi-static information.

Optionally, the second indication information is a MAC-CE (for example, a MAC-CE for semi-persistent access link beam indication).

Optionally, second beam indication information may be beam information indicated/ updated by a MAC-CE (associated with the second time resource), or the second beam indication information may be a second beam corresponding to/associated with the second time resource among resources (for example, semi-persistent forwarding resources) indicated by a MAC-CE. The advantage of the method is that whether the second beam information is the information included in the forwarding resource configuration indicated by the MAC-CE or the beam information updated/indicated by the MAC-CE can be clarified, and the base station and the NCR can be avoided from having different understandings of beams of the overlapping part.

Optionally, the second indication information being the semi-static information means that the second indication information is carried by RRC.

Optionally, the second indication information is carried by RRC. In other words, the second indication information indicating the second beam information (e.g., beam index) and the corresponding second time resource may be understood as RRC indicating the second beam information (e.g., beam index) and the corresponding/associated second time resource. For example, the RRC signaling is RRC signaling for indicating a periodic forwarding resource (set) (for example, NCR-PeriodicFwdResourceSet). For example, the RRC signaling is RRC signaling for indicating a periodic forwarding resource (for example, NCR-PeriodicFwdResource). Optionally, the resource includes a beam index and a time resource configuration (or configuration index). Optionally, the resource includes a pair of a beam index and a time resource configuration (or configuration index).

Optionally, the first indication information indicating the first beam information and the corresponding first time resource means that the first indication information indicates that the NCR-Fwd applies/uses the first beam information in the first time resource (to perform forwarding, or to perform uplink/downlink forwarding).

Optionally, the second indication information indicating the second beam information and the corresponding second time resource means that the second indication information indicates that the NCR-Fwd applies/uses the second beam information in the second time resource (to perform forwarding, or to perform uplink/downlink forwarding).

Optionally, the NCR not applying/using the second indication information or the first indication information means that the NCR does not apply/use the second beam information in the second time resource (to perform forwarding, or to perform uplink/downlink forwarding); or the NCR does not apply/use the first beam information in the first time resource (to perform forwarding, or to perform uplink/downlink forwarding).

Optionally, the NCR applying/using the first indication information or the second indication information means that the NCR applies/uses the first beam information in the first time resource (to perform forwarding, or to perform uplink/downlink forwarding); or the NCR applies/uses the second beam information in the second time resource (to perform forwarding, or to perform uplink/downlink forwarding).

Optionally, the NCR applying/using the first indication information or the second indication information in the overlapping part of the first time resource and the second time resource means that the NCR applies/uses the first beam information or the second beam information in the overlapping part of the first time resource and the second time resource (to perform forwarding, or to perform uplink/downlink forwarding).

Optionally, the NCR not applying/using the first indication information or the second indication information in the overlapping part of the first time resource and the second time resource means that the NCR does not apply/use the first beam information or the second beam information in the overlapping part of the first time resource and the second time resource (to perform forwarding, or to perform uplink/downlink forwarding).

Optionally, the first beam (information) and the second beam (information) are different. For example, the first beam information corresponds to/is associated with the first beam. The second beam information corresponds to/is associated with the second beam. Optionally, the first beam information and the second beam information are different. Optionally, the first beam information and the second beam information being different means that an index corresponding to the first beam information is different from an index corresponding to the second beam information. For example, the first beam information is beam #1 (that is, a beam index is 1); the second beam information is beam #2 (that is, a beam index is 2). At this time, the first beam information and the second beam information are different. It can be understood that the NCR will perform the above behavior under the condition that the first beam information and the second beam information are different.

This example provides a method for determining the (access link) beam of the NCR. The method can enable the NCR to correctly process/use/determine the corresponding beam in the case that multiple beam-related indications are obtained, thereby improving the link quality of the access link and improving the performance of the communication system.

### EXAMPLE 2

The NCR (for example, the NCR-MT) receives a first indication information and a second indication information; in which,
the first indication information indicates first beam information (e.g., beam index) and corresponding/associated first time resource; or the first indication information indicates first time resource and corresponding/associated first beam information (e.g., beam index);
the second indication information indicates second beam information (e.g., beam index) and corresponding/associated second time resource; or the second indication information indicates second time resource and corresponding/associated second beam information (e.g., beam index);
if the first time resource overlaps with the second time resource (or the first time resource and the second time resource is the same), the NCR (for example, the NCR-Fwd) does not apply/use the second indication information or the first indication information; or the NCR (for example, the NCR-Fwd) applies/uses the first indication information or the second indication information; or the NCR (for example, the NCR-Fwd) applies/uses the first indication information or the second indication information in an overlapping part of the first time resource and the second time resource; or the NCR (for example, the NCR-Fwd) does not apply/use the first indication information or the second indication information in the overlapping part of the first time resource and the second time resource.

Optionally, the NCR performs the above operations regardless of whether the first time resource is associated with a priority indicator and/or whether the second time resource is associated with a priority indicator. Optionally, the first time resource being associated with the priority indicator means that a semi-persistent forwarding resource (set) parameter associated with/corresponding to the first time resource is configured with the priority indicator. Optionally, the first time resource being not associated with the priority indicator means that the semi-persistent forwarding resource (set) parameter associated with/corresponding to the first time resource is not configured with the priority indicator. Optionally, the second time resource being associated with the priority indicator means that a periodic forwarding resource (set) parameter associated with/corresponding to the second time resource is configured with the priority indicator. Optionally, the second time resource being not associated with the priority indicator means that the periodic forwarding resource (set) parameter associated with/corresponding to the second time resource is not configured with the priority indicator.

Optionally, the priority indicator is used to determine a priority between a periodic beam indication or a semi-persistent beam indication and an aperiodic beam indication. For example, when the priority indicator is configured, time resources corresponding to/indicated by the periodic beam indication, or time resources corresponding to/indicated by the semi-persistent beam indication have a higher priority than time resources corresponding to/indicated by the aperiodic beam indication.

Optionally, the overlapping part may be a set of symbols. Optionally, the overlapping part may be a set of slots. Optionally, a subcarrier spacing (SCS) of (associated with) the overlapping part is based on/refers to an SCS of the first time resource. Optionally, the subcarrier spacing (SCS) of (associated with) the overlapping part is based on/refers to an SCS of the second time resource.

Optionally, the first indication information is semi-persistent indication information.

Optionally, the first indication information is a MAC-CE (for example, a MAC-CE for semi-persistent access link beam indication).

Optionally, the first beam indication information may be beam information indicated/updated by a MAC-CE (associated with the first time resource), or the first beam indication information may be a first beam corresponding to/associated with the first time resource among resources (for example, semi-persistent forwarding resources) indicated by a MAC-CE. The advantage of the method is that whether the second beam information is the information included in the forwarding resource configuration indicated by the MAC-CE or the beam information updated by the MAC-CE can be clarified, and the base station and the NCR can be avoided from having different understandings of the overlapping part.

Optionally, the second indication information is semi-static information.

Optionally, the second indication information is carried by RRC. In other words, the second indication information indicating the second beam information (e.g., beam index) and the corresponding second time resource may be understood as RRC indicating the second beam information (e.g., beam index) and the corresponding/associated second time resource. For example, the RRC signaling is RRC signaling for indicating a periodic forwarding resource (set) (for example, NCR-PeriodicFwdResourceSet). For example, the RRC signaling is RRC signaling for indicating a periodic forwarding resource (for example, NCR-PeriodicFwdResource). Optionally, the resource includes a beam index and a time resource configuration (or configuration index). Optionally, the resource includes a pair of a beam index and a time resource configuration (or configuration index).

Optionally, the first indication information indicating the first beam information and the corresponding first time resource means that the first indication information indicates that the NCR-Fwd applies/uses the first beam information in the first time resource (to perform forwarding, or to perform uplink/downlink forwarding).

Optionally, the second indication information indicating the second beam information and the corresponding second time resource means that the second indication information indicates that the NCR-Fwd applies/uses the second beam information in the second time resource (to perform forwarding, or to perform uplink/downlink forwarding).

Optionally, the NCR not applying/using the second indication information or the first indication information means that the NCR does not apply/use the second beam information in the second time resource (to perform forwarding, or to perform uplink/downlink forwarding); or the NCR does not apply/use the first beam information in the first time resource (to perform forwarding, or to perform uplink/downlink forwarding).

Optionally, the NCR applying/using the first indication information or the second indication information means that the NCR applies/uses the first beam information in the first time resource (to perform forwarding, or to perform uplink/downlink forwarding); or the NCR applies/uses the second beam information in the second time resource (to perform forwarding, or to perform uplink/downlink forwarding).

Optionally, the NCR applying/using the first indication information or the second indication information in the overlapping part of the first time resource and the second time resource means that the NCR applies/uses the first beam information or the second beam information in the overlapping part of the first time resource and the second time resource (to perform forwarding, or to perform uplink/downlink forwarding).

Optionally, the NCR not applying/using the first indication information or the second indication information in the overlapping part of the first time resource and the second time resource means that the NCR does not apply/use the first beam information or the second beam information in the overlapping part of the first time resource and the second time resource (to perform forwarding, or to perform uplink/downlink forwarding).

Optionally, the first beam (information) and the second beam (information) are different. For example, the first beam information corresponds to/is associated with the first beam. The second beam information corresponds to/is associated with the second beam. Optionally, the first beam information and the second beam information are different. Optionally, the first beam information and the second beam information being different means that an index corresponding to the first beam information is different from an index corresponding to the second beam information. For example, the first beam information is beam #1 (that is, a beam index is 1); the second beam information is beam #2 (that is, a beam index is 2). At this time, the first beam information and the second beam information are different. It can be understood that the NCR will perform the above behavior under the condition that the first beam information and the second beam information are different.

This example provides a method for determining the (access link) beam of the NCR. The method can enable the NCR to correctly process/use/determine the corresponding beam in the case that multiple beam-related indications are obtained, thereby improving the link quality of the access link and improving the performance of the communication system.

### EXAMPLE 3

A network device (for example, a gNB) transmits first indication information and second indication information to an NCR (for example, an NCR-MT); in which,
the first indication information indicates first beam information (e.g., beam index) and corresponding/associated first time resource; or the first indication information indicates first time resource and corresponding/associated first beam information (e.g., beam index);
the second indication information indicates second beam information (e.g., beam index) and corresponding/associated second time resource; or the second indication information indicates second time resource and corresponding/associated second beam information (e.g., beam index);
if the first time resource overlaps with the second time resource (or the first time resource and the second time resource is the same), the first beam information and the second beam information are (also) the same; or,
if the first beam information and the second beam information are different (for example, the corresponding beams are different, for example, beam IDs are different), the first time resource do not overlap with the second time resource (for example, the first time resource and the second time resource is time-division multiplexed), or the first time resource and the second time resource is different.

Optionally, the network device performs the above operations regardless of whether the first time resource is associated with a priority indicator and/or whether the second time resource is associated with a priority indicator. Optionally, the first time resource being associated with the priority indicator means that a semi-persistent forwarding resource (set) parameter associated with/corresponding to the first time resource is configured with the priority indicator. Optionally, the first time resource being not associated with the priority indicator means that the semi-persistent forwarding resource (set) parameter associated with/corresponding to the first time resource is not configured with the priority indicator. Optionally, the second time resource being associated with the priority indicator means that a semi-persistent forwarding resource (set) parameter associated with/corresponding to the second time resource is configured with the priority indicator. Optionally, the second time resource being not associated with the priority indicator means that the semi-persistent forwarding resource (set) parameter associated with/corresponding to the second time resource is not configured with the priority indicator.

Optionally, overlapping may be overlapping in a set of symbols. Optionally, overlapping may be overlapping in a set of slots. Optionally, a subcarrier spacing (SCS) of (associated with) the overlapping part is based on/refers to an SCS of the first time resource. Optionally, the subcarrier spacing (SCS) of (associated with) the overlapping part is based on/refers to an SCS of the second time resource.

Optionally, the first indication information is semi-persistent indication information.

Optionally, the first indication information is a MAC-CE (for example, a MAC-CE for semi-persistent access link beam indication).

Optionally, the first beam indication information may be beam information indicated/updated by a MAC-CE (associated with the first time resource), or the first beam indication information may be a first beam corresponding to/associated with the first time resource among resources (for example, semi-persistent forwarding resources) indicated by a MAC-CE. The advantage of the method is that whether the first beam information is the information included in the forwarding resource configuration indicated by the MAC-CE or the beam information updated by the MAC-CE can be clarified, and the base station and the NCR can be avoided from having different understandings of the overlapping part.

Optionally, the second indication information is semi-persistent information.

Optionally, the second indication information is a MAC-CE (for example, a MAC-CE for semi-persistent access link beam indication).

Optionally, second beam indication information may be beam information indicated/updated by a MAC-CE (associated with the second time resource), or the second beam indication information may be a second beam corresponding to/associated with the second time resource among resources (for example, semi-persistent forwarding resources) indicated by a MAC-CE. The advantage of the method is that whether the second beam information is the information included in the forwarding resource configuration indicated by the MAC-CE or the beam information updated by the MAC-CE can be clarified, and the base station and the NCR can be avoided from having different understandings of the overlapping part.

Optionally, an RRC parameter (NCR-SemiPersistentFwdResourceSet) associated with/corresponding to the first indication information that is used to indicate a semi-persistent forwarding resource (set) and an RRC parameter (NCR-SemiPersistentFwdResourceSet) associated with/corresponding to the second indication information that is used to indicate a semi-persistent forwarding resource (set) are different. That is, (for the description of the example,) the first indication information and the second indication information satisfy the following condition: the RRC parameter (NCR-SemiPersistentFwdResourceSet) associated with/corresponding to the first indication information that is used to indicate the semi-persistent forwarding resource (set) and the RRC parameter (NCR-SemiPersistentFwdResourceSet) associated with/corresponding to the second indication information that is used to indicate the semi-persistent forwarding resource (set) are different.

Optionally, a MAC-CE associated with/corresponding to the first indication information and a MAC-CE associated with/corresponding to the second indication information are different. That is, (for the description of the example,) the first indication information and the second indication information satisfy the following condition: the MAC-CE associated with/corresponding to the first indication information and the MAC-CE associated with/corresponding to the second indication information are different.

Optionally, the first indication information indicating the first beam information and the corresponding/associated first time resource means that the first indication information indicates that the NCR-Fwd applies/uses the first beam information in the first time resource (to perform forwarding, or to perform uplink/downlink forwarding).

Optionally, the second indication information indicating the second beam information and the corresponding/associated second time resource means that the second indication information indicates that the NCR-Fwd applies/uses the second beam information in the second time resource (to perform forwarding, or to perform uplink/downlink forwarding).

This example provides a method for limiting the (access link) beam of the NCR. The method can enable the NCR to avoid the conflict in the case that multiple beam-related indications are obtained, thereby improving the link quality of the access link and improving the performance of the communication system.

### EXAMPLE 4

The NCR (for example, the NCR-MT) receives a first indication information and a second indication information; in which, the first indication information indicates first beam information (e.g., beam index) and corresponding/associated first time resource; or the first indication information indicates first time resource and corresponding/associated first beam information (e.g., beam index);
the second indication information indicates second beam information (e.g., beam index) and corresponding/associated second time resource; or the second indication information indicates second time resource and corresponding/associated second beam information (e.g., beam index);
if the first time resource overlaps with the second time resource (or the first time resource and the second time resource is the same), the NCR (for example, the NCR-Fwd) does not expect that the first beam information and the second beam information are different, or the NCR (for example, the NCR-Fwd) expects that the first beam information and the second beam information are the same; or,
if the first beam information and the second beam information are different (for example, the corresponding beams are different, for example, beam IDs are different), the NCR (for example, the NCR-Fwd) does not expect that the first time resource overlaps with the second time resource, or the NCR (for example, the NCR-Fwd) does not expect that the first time resource and the second time resource is the same, or the NCR (for example, the NCR-Fwd) expects that the first time resource do not overlap with the second time resource (for example, the first time resource and the second time resource is time-division multiplexed), or the NCR (for example, the NCR-Fwd) expects that the first time resource and the second time resource is different.

Optionally, the NCR performs the above operations regardless of whether the first time resource is associated with a priority indicator and/or whether the second time resource is associated with a priority indicator. Optionally, the first time resource being associated with the priority indicator means that a semi-persistent forwarding resource (set) parameter associated with/corresponding to the first time resource is configured with the priority indicator. Optionally, the first time resource being not associated with the priority indicator means that the semi-persistent forwarding resource (set) parameter associated with/corresponding to the first time resource is not configured with the priority indicator. Optionally, the second time resource being associated with the priority indicator means that a semi-persistent forwarding resource (set) parameter associated with/corresponding to the second time resource is configured with the priority indicator. Optionally, the second time resource being not associated with the priority indicator means that the semi-persistent forwarding resource (set) parameter associated with/corresponding to the second time resource is not configured with the priority indicator.

Optionally, overlapping may be overlapping in a set of symbols. Optionally, overlapping may be overlapping in a set of slots. Optionally, a subcarrier spacing (SCS) of (associated with) the overlapping part is based on/refers to an SCS of the first time resource. Optionally, the subcarrier spacing (SCS) of (associated with) the overlapping part is based on/refers to an SCS of the second time resource.

Optionally, the first indication information is semi-persistent indication information.

Optionally, the first indication information is a MAC-CE (for example, a MAC-CE for semi-persistent access link beam indication).

Optionally, the first beam indication information may be beam information indicated/updated by a MAC-CE (associated with the first time resource), or the first beam indication information may be a first beam corresponding to/associated with the first time resource among resources (for example, semi-persistent forwarding resources) indicated by a MAC-CE. The advantage of the method is that whether the first beam information is the information included in the forwarding resource configuration indicated by the MAC-CE or the beam information updated by the MAC-CE can be clarified, and the base station and the NCR can be avoided from having different understandings of the overlapping part.

Optionally, the second indication information is semi-persistent information.

Optionally, the second indication information is a MAC-CE (for example, a MAC-CE for semi-persistent access link beam indication).

Optionally, second beam indication information may be beam information indicated/updated by a MAC-CE (associated with the second time resource), or the second beam indication information may be a second beam corresponding to/associated with the second time resource among resources (for example, semi-persistent forwarding resources) indicated by a MAC-CE. The advantage of the method is that whether the second beam information is the information included in the forwarding resource configuration indicated by the MAC-CE or the beam information updated by the MAC-CE can be clarified, and the base station and the NCR can be avoided from having different understandings of the overlapping part.

Optionally, an RRC parameter (NCR-SemiPersistentFwdResourceSet) associated with/corresponding to the first indication information that is used to indicate a semi-persistent forwarding resource (set) and an RRC parameter (NCR-SemiPersistentFwdResourceSet) associated with/corresponding to the second indication information that is used to indicate a semi-persistent forwarding resource (set) are different. That is, (for the description of the example,) the first indication information and the second indication information satisfy the following condition: the RRC parameter (NCR-SemiPersistentFwdResourceSet) associated with/corresponding to the first indication information that is used to indicate the semi-persistent forwarding resource (set) and the RRC parameter (NCR-SemiPersistentFwdResourceSet) associated with/corresponding to the second indication information that is used to indicate the semi-persistent forwarding resource (set) are different.

Optionally, a MAC-CE associated with/corresponding to the first indication information and a MAC-CE associated with/corresponding to the second indication information are different. That is, (for the description of the example,) the first indication information and the second indication information satisfy the following condition: the MAC-CE associated with/corresponding to the first indication information and the MAC-CE associated with/corresponding to the second indication information are different.

Optionally, the first indication information indicating the first beam information and the corresponding/associated first time resource means that the first indication information indicates that the NCR-Fwd applies/uses the first beam information in the first time resource (to perform forwarding, or to perform uplink/downlink forwarding).

Optionally, the second indication information indicating the second beam information and the corresponding/associated second time resource means that the second indication information indicates that the NCR-Fwd applies/uses the second beam information in the second time resource (to perform forwarding, or to perform uplink/downlink forwarding).

This example provides a method for limiting the (access link) beam of the NCR. The method can enable the NCR to avoid the conflict in the case that multiple beam-related indications are obtained, thereby improving the link quality of the access link and improving the performance of the communication system.

### EXAMPLE 5

A network device (for example, a gNB) transmits first indication information and second indication information to an NCR (for example, an NCR-MT); in which,
the first indication information indicates first beam information (e.g., beam index) and corresponding/associated first time resource; or the first indication information indicates first time resource and corresponding/associated first beam information (e.g., beam index);
the second indication information indicates second beam information (e.g., beam index) and corresponding/associated second time resource; or the second indication information indicates second time resource and corresponding/associated second beam information (e.g., beam index);
if the first time resource overlaps with the second time resource (or the first time resource and the second time resource is the same), the first beam information and the second beam information are (also) the same; or,
if the first beam information and the second beam information are different (for example, the corresponding beams are different, for example, beam IDs are different), the first time resource do not overlap with the second time resource (for example, the first time resource and the second time resource is time-division multiplexed), or the first time resource and the second time resource is different.

Optionally, the network device performs the above operations regardless of whether the first time resource is associated with a priority indicator and/or whether the second time resource is associated with a priority indicator. Optionally, the first time resource being associated with the priority indicator means that a periodic forwarding resource (set) parameter associated with/corresponding to the first time resource is configured with the priority indicator. Optionally, the first time resource being not associated with the priority indicator means that the periodic forwarding resource (set) parameter associated with/corresponding to the first time resource is not configured with the priority indicator. Optionally, the second time resource being associated with the priority indicator means that a periodic forwarding resource (set) parameter associated with/corresponding to the second time resource is configured with the priority indicator. Optionally, the second time resource being not associated with the priority indicator means that the periodic forwarding resource (set) parameter associated /th/ corresponding to the second time resource is not configured with the priority indicator.

Optionally, overlapping may be overlapping in a set of symbols. Optionally, overlapping may be overlapping in a set of slots. Optionally, a subcarrier spacing (SCS) of (associated with) the overlapping part is based on/refers to an SCS of the first time resource. Optionally, the subcarrier spacing (SCS) of (associated with) the overlapping part is based on/refers to an SCS of the second time resource.

Optionally, the first indication information is semi-static information.

Optionally, the first indication information is carried by RRC. In other words, the first indication information indicating the first beam information (e.g., beam index) and the corresponding first time resource may be understood as RRC indicating the first beam information (e.g., beam index) and the corresponding/associated first time resource. For example, the RRC signaling is RRC signaling for indicating a periodic forwarding resource (set) (for example, NCR-PeriodicFwdResourceSet). For example, the RRC signaling is RRC signaling for indicating a periodic forwarding resource (for example, NCR-PeriodicFwdResource). Optionally, the resource includes a beam index and a time resource configuration (or configuration index). Optionally, the resource includes a pair of a beam index and a time resource configuration (or configuration index).

Optionally, the second indication information is semi-static information.

Optionally, the second indication information is carried by RRC. In other words, the second indication information indicating the second beam information (e.g., beam index) and the corresponding/associated second time resource may be understood as RRC indicating the second beam information (e.g., beam index) and the corresponding/associated second time resource. For example, the RRC signaling is RRC signaling for indicating a periodic forwarding resource (set) (for example, NCR-PeriodicFwdResourceSet). For example, the RRC signaling is RRC signaling for indicating a periodic forwarding resource (for example, NCR-PeriodicFwdResource). Optionally, the resource includes a beam index and a time resource configuration (or configuration index). Optionally, the resource includes a pair of a beam index and a time resource configuration (or configuration index).

Optionally, an RRC parameter (NCR-PeriodicFwdResourceSet) associated with/corresponding to the first indication information that is used to indicate a periodic forwarding resource (set) and an RRC parameter (NCR-PeriodicFwdResourceSet) associated with/corresponding to the second indication information that is used to indicate a periodic forwarding resource (set) are different. That is, (for the description of the example,) the first indication information and the second indication information satisfy the following condition: the RRC parameter (NCR-PeriodicFwdResourceSet) associated with/corresponding to the first indication information that is used to indicate the periodic forwarding resource (set) and the RRC parameter (NCR-PeriodicFwdResourceSet) associated with/corresponding to the second indication information that is used to indicate the periodic forwarding resource (set) are different.

Optionally, the first indication information indicating the first beam information and the corresponding/associated first time resource means that the first indication information indicates that the NCR-Fwd applies/uses the first beam information in the first time resource (to perform forwarding, or to perform uplink/downlink forwarding).

Optionally, the second indication information indicating the second beam information and the corresponding/associated second time resource means that the second indication information indicates that the NCR-Fwd applies/uses the second beam information in the second time resource (to perform forwarding, or to perform uplink/downlink forwarding).

This example provides a method for limiting the (access link) beam of the NCR. The method can enable the NCR to correctly process/use/determine the corresponding beam in the case that multiple beam-related indications are obtained, thereby improving the link quality of the access link and improving the performance of the communication system.

### EXAMPLE 6

The NCR (for example, the NCR-MT) receives a first indication information and a second indication information; in which,
the first indication information indicates first beam information (e.g., beam index) and corresponding/associated first time resource; or the first indication information indicates first time resource and corresponding/associated first beam information (e.g., beam index);
the second indication information indicates second beam information (e.g., beam index) and corresponding/associated second time resource; or the second indication information indicates second time resource and corresponding/associated second beam information (e.g., beam index);
if the first time resource overlaps with the second time resource, the NCR (for example, the NCR-Fwd) does not expect that the first beam information and the second beam information are different, or the NCR (for example, the NCR-Fwd) expects that the first beam information and the second beam information are the same; or,
if the first beam information and the second beam information are different (for example, the corresponding beams are different, for example, beam IDs are different), the NCR (for example, the NCR-Fwd) does not expect that the first time resource overlaps with the second time resource, or the NCR (for example, the NCR-Fwd) does not expect that the first time resource and the second time resource is the same, or the NCR (for example, the NCR-Fwd) expects that the first time resource do not overlap with the second time resource (for example, the first time resource and the second time resource is time-division multiplexed), or the NCR (for example, the NCR-Fwd) expects that the first time resource and the second time resource is different.

Optionally, the NCR performs the above operations regardless of whether the first time resource is associated with a priority indicator and/or whether the second time resource is associated with a priority indicator. Optionally, the first time resource being associated with the priority indicator means that a periodic forwarding resource (set) parameter associated with/corresponding to the first time resource is configured with the priority indicator. Optionally, the first time resource being not associated with the priority indicator means that the periodic forwarding resource (set) parameter associated with/corresponding to the first time resource is not configured with the priority indicator. Optionally, the second time resource being associated with the priority indicator means that a periodic forwarding resource (set) parameter associated with/corresponding to the second time resource is configured with the priority indicator. Optionally, the second time resource being not associated with the priority indicator means that the periodic forwarding resource (set) parameter associated /th/ corresponding to the second time resource is not configured with the priority indicator.

Optionally, overlapping may be overlapping in a set of symbols. Optionally, overlapping may be overlapping in a set of slots. Optionally, a subcarrier spacing (SCS) of (associated with) the overlapping part is based on/refers to an SCS of the first time resource. Optionally, the subcarrier spacing (SCS) of (associated with) the overlapping part is based on/refers to an SCS of the second time resource.

Optionally, the first indication information is semi-static information.

Optionally, the first indication information is carried by RRC. In other words, the first indication information indicating the first beam information (e.g., beam index) and the corresponding first time resource may be understood as RRC indicating the first beam information (e.g., beam index) and the corresponding/associated first time resource. For example, the RRC signaling is RRC signaling for indicating a periodic forwarding resource (set) (for example, NCR-PeriodicFwdResourceSet). For example, the RRC signaling is RRC signaling for indicating a periodic forwarding resource (for example, NCR-PeriodicFwdResource). Optionally, the resource includes a beam index and a time resource configuration (or configuration index). Optionally, the resource includes a pair of a beam index and a time resource configuration (or configuration index).

Optionally, the second indication information is semi-static information.

Optionally, the second indication information is carried by RRC. In other words, the second indication information indicating the second beam information (e.g., beam index) and the corresponding/associated second time resource may be understood as RRC indicating the second beam information (e.g., beam index) and the corresponding/associated second time resource. For example, the RRC signaling is RRC signaling for indicating a periodic forwarding resource (set) (for example, NCR-PeriodicFwdResourceSet). For example, the RRC signaling is RRC signaling for indicating a periodic forwarding resource (for example, NCR-PeriodicFwdResource). Optionally, the resource includes a beam index and a time resource configuration (or configuration index). Optionally, the resource includes a pair of a beam index and a time resource configuration (or configuration index).

Optionally, an RRC parameter (NCR-PeriodicFwdResourceSet) associated /th/ corresponding to the first indication information that is used to indicate a periodic forwarding resource (set) and an RRC parameter (NCR-PeriodicFwdResourceSet) associated with/corresponding to the second indication information that is used to indicate a periodic forwarding resource (set) are different. That is, (for the description of the example,) the first indication information and the second indication information satisfy the following condition: the RRC parameter (NCR-PeriodicFwdResourceSet) associated with/corresponding to the first indication information that is used to indicate the periodic forwarding resource (set) and the RRC parameter (NCR-PeriodicFwdResourceSet) associated with/corresponding to the second indication information that is used to indicate the periodic forwarding resource (set) are different.

Optionally, the first indication information indicating the first beam information and the corresponding/associated first time resource means that the first indication information indicates that the NCR-Fwd applies/uses the first beam information in the first time resource (to perform forwarding, or to perform uplink/downlink forwarding).

Optionally, the second indication information indicating the second beam information and the corresponding/associated second time resource means that the second indication information indicates that the NCR-Fwd applies/uses the second beam information in the second time resource (to perform forwarding, or to perform uplink/downlink forwarding).

This example provides a method for limiting the (access link) beam of the NCR. The method can enable the NCR to correctly process/use/determine the corresponding beam in the case that multiple beam-related indications are obtained, thereby improving the link quality of the access link and improving the performance of the communication system.

### EXAMPLE 7

The NCR (for example, the NCR-MT) receives first indication information, second indication information and third indication information; in which,
the first indication information indicates first beam information (e.g., beam index) and corresponding/associated first time resource; or the first indication information indicates first time resource and corresponding/associated first beam information (e.g., beam index);
the second indication information indicates second beam information (e.g., beam index) and corresponding/associated second time resource; or the second indication information indicates second time resource and corresponding/associated second beam information (e.g., beam index);
the third indication information indicates third beam information (e.g., beam index) and corresponding/associated third time resources; or the third indication information indicates third time resources and corresponding/associated third beam information (e.g., beam index).

Optionally, if the first time resource, the second time resource and the third time resources overlap (or the first time resource, the second time resource and the third time resources are the same), the NCR (for example, the NCR-Fwd) applies/uses one of the first indication information (first beam information), the second indication information (second beam information) and the third indication information (second beam information); or the NCR (for example, the NCR-Fwd) applies/uses one of the first indication information (first beam information), the second indication information (second beam information) and the third indication information (third beam information) in an overlapping part of the first time resource, the second time resource and the third time resources.

Optionally, if the first time resource, the second time resource and the third time resources overlap (or the first time resource, the second time resource and the third time resources are the same), the NCR (for example, the NCR-Fwd) applying/using one of the first indication information (first beam information), the second indication information (second beam information) and the third indication information (third beam information) in the overlapping part of the first time resource, the second time resource and the third time resources includes at least one of:
if the first time resource, the second time resource and the third time resources overlap (or the first time resource, the second time resource and the third time resources are the same), and the first time resource is not associated/configured with a priority indicator (for example, a semi-persistent forwarding resource (list/set) or a periodic forwarding resource (list/set) associated with the first time resource is not configured with a priority indicator), the NCR (for example, the NCR-Fwd) /plies/ uses the third indication information (third beam information);
if the first time resource, the second time resource and the third time resources overlap (or the first time resource, the second time resource and the third time resources are the same), and the first time resource is associated/configured with a priority indicator (for example, a semi-persistent forwarding resource (list/set) or a periodic forwarding resource (list/set) associated with the first time resource is configured with a priority indicator), the NCR (for example, the NCR-Fwd) /plies/ uses the first indication information (third beam information);
if the first time resource, the second time resource and the third time resources overlap (or the first time resource, the second time resource and the third time resources are the same), and the first beam information and the third beam information are different, and the first time resource is not associated/configured with a priority indicator (for example, a semi-persistent forwarding resource (list/set) or a periodic forwarding resource (list/set) associated with the first time resource is not configured with a priority indicator), the NCR (for example, the NCR-Fwd) applies/uses the third indication information (third beam information);
if the first time resource, the second time resource and the third time resources overlap (or the first time resource, the second time resource and the third time resources are the same), and the first beam information and the third beam information are different, and the first time resource is associated/configured with a priority indicator (for example, a semi-persistent forwarding resource (list/set) or a periodic forwarding resource (list/set) associated with the first time resource is configured with a priority indicator), the NCR (for example, the NCR-Fwd) applies/uses the first indication information (third beam information);
if the first time resource, the second time resource and the third time resources overlap (or the first time resource, the second time resource and the third time resources are the same), and the first time resource and the second time resource is (both) not associated/configured with a priority indicator (for example, a semi-persistent forwarding resource (list/set) associated with the first time resource and a periodic forwarding resource (list/set) associated with the second time resource is not configured with a priority indicator), the NCR (for example, the NCR-Fwd) applies/uses the third indication information (third beam information);
if the first time resource, the second time resource and the third time resources overlap (or the first time resource, the second time resource and the third time resources are the same), and the first beam information and the third beam information are different, and the first time resource and the second time resource is (both) not associated/configured with a priority indicator (for example, a semi-persistent forwarding resource (list/set) associated with the first time resource and a periodic forwarding resource (list/set) associated with the second time resource is not configured with a priority indicator), the NCR (for example, the NCR-Fwd) applies/uses the third indication information (third beam information);
if the first time resource, the second time resource and the third time resources overlap (or the first time resource, the second time resource and the third time resources are the same), and the first time resource and the second time resource is (both) associated/configured with a priority indicator (for example, a semi-persistent forwarding resource (list/set) associated with the first time resource and a periodic forwarding resource (list/set) associated with the second time resource is configured with a priority indicator), the NCR (for example, the NCR-Fwd) applies/uses the first indication information (third beam information);
if the first time resource, the second time resource and the third time resources overlap (or the first time resource, the second time resource and the third time resources are the same), and the first beam information and the third beam information are different, and the first time resource and the second time resource is (both) associated/configured with a priority indicator (for example, a semi-persistent forwarding resource (list/set) associated with the first time resource and a periodic forwarding resource (list/set) associated with the second time resource is configured with a priority indicator), the NCR (for example, the NCR-Fwd) applies/uses the first indication information (third beam information);
if the first time resource, the second time resource and the third time resources overlap (or the first time resource, the second time resource and the third time resources are the same), and one of the first time resource and the second time resource is (not) associated/configured with a priority indicator (for example, a semi-persistent forwarding resource (list/set) associated with the first time resource and a periodic forwarding resource (list/set) associated with the second time resource is (not) configured with a priority indicator), the NCR (for example, the NCR-Fwd) applies/uses beam information corresponding to/related to time resources (not) associated with the priority indicator among the first time resource and the second time resource;
if the first time resource, the second time resource and the third time resources overlap (or the first time resource, the second time resource and the third time resources are the same), and beam information associated with time resources (not) associated with a priority indicator among the first time resource and the second time resource is different from the third beam information, and one of the first time resource and the second time resource is (not) associated/configured with a priority indicator (for example, a semi-persistent forwarding resource (list/set) associated with the first time resource or a periodic forwarding resource (list/set) associated with the second time resource is (not) configured with a priority indicator), the NCR (for example, the NCR-Fwd) applies/uses the beam information corresponding to/related to the time resources (not) associated with the priority indicator among the first time resource and the second time resource.

Optionally, the overlapping part may be a set of symbols. Optionally, the overlapping part may be a set of slots. Optionally, a subcarrier spacing (SCS) of (associated with) the overlapping part is based on/refers to an SCS of the first time resource. Optionally, the subcarrier spacing (SCS) of (associated with) the overlapping part is based on/refers to an SCS of the third time resources. Optionally, the subcarrier spacing (SCS) of (associated with) the overlapping part is based on/refers to an SCS of the time resources (not) associated with the priority indicator among the first time resource and the second time resource. Optionally, the subcarrier spacing (SCS) of (associated with) the overlapping part is based on/refers to an SCS of the second time resource. The advantage of the method is that the subcarrier spacing corresponding to the time unit of the overlapping part can be clarified, and the base station and the NCR can be avoided from having different understandings of the overlapping part.

Optionally, the priority indicator is used to determine a priority between a periodic beam indication or a semi-persistent beam indication and an aperiodic beam indication. For example, when the priority indicator is configured, time resources corresponding to/indicated by the periodic beam indication, or time resources corresponding to/indicated by the semi-persistent beam indication have a higher priority than time resources corresponding to/indicated by the aperiodic beam indication.

Optionally, the first indication information is semi-persistent indication information. For example, beam indication information for a semi-persistent access link beam.

Optionally, the first indication information is a MAC-CE (for example, a MAC-CE for semi-persistent access link beam indication).

Optionally, the first beam indication information may be beam information indicated/updated by a MAC-CE (associated with the second time resource), or the first beam indication information may be a first beam corresponding to/associated with the first time resource among resources (for example, semi-persistent forwarding resources) indicated by a MAC-CE. The advantage of the method is that whether the first beam information is the information included in the forwarding resource configuration indicated by the MAC-CE or the beam information updated/indicated by the MAC-CE can be clarified, and the base station and the NCR can be avoided from having different understandings of beams of the overlapping part.

Optionally, the second indication information is semi-static information.

Optionally, the second indication information is carried by RRC. In other words, the second indication information indicating the second beam information (e.g., beam index) and the corresponding second time resource may be understood as RRC indicating the second beam information (e.g., beam index) and the corresponding/associated second time resource. For example, the RRC signaling is RRC signaling for indicating a periodic forwarding resource (set) (for example, NCR-PeriodicFwdResourceSet). For example, the RRC signaling is RRC signaling for indicating a periodic forwarding resource (for example, NCR-PeriodicFwdResource). Optionally, the resource includes a beam index and a time resource configuration (or configuration index). Optionally, the resource includes a pair of a beam index and a time resource configuration (or configuration index).

Optionally, the third indication information is dynamic indication information.

Optionally, the third indication information is carried by a DCI format. Optionally, the DCI format is used to notify the aperiodic beam indication and associated time resources. DCI format 5_0 or DCI format 2_8 is described as an example below. Optionally, the first indication information is carried by DCI format 5_0 or DCI format 2_8. In other words, the third indication information indicating the third beam information (e.g., beam index) and the corresponding/associated third time resources may be understood as DCI format 5_0 or DCI format 2_8 indicating the third beam information (e.g., beam index) and the corresponding/associated third time resources. For example, the time resources are associated with/correspond to aperiodic forwarding resources. For example, the aperiodic forwarding resources are configured by RRC signaling (AperiodicFwdResource).

Optionally, the first indication information indicating the first beam information and the corresponding first time resource means that the first indication information indicates that the NCR-Fwd applies/uses the first beam information in the first time resource (to perform forwarding, or to perform uplink/downlink forwarding).

Optionally, the second indication information indicating the second beam information and the corresponding second time resource means that the second indication information indicates that the NCR-Fwd applies/uses the second beam information in the second time resource (to perform forwarding, or to perform uplink/downlink forwarding).

Optionally, the third indication information indicating that the third beam information and the corresponding third time resources means that the third indication information indicates that the NCR-Fwd applies/uses the third beam information in the third time resources (to perform forwarding, or to perform uplink/downlink forwarding).

Optionally, the NCR applying/using the first indication information or the second indication information or the third indication information means that the NCR applies/uses the first beam information in the first time resource (to perform forwarding, or to perform uplink/downlink forwarding); or the NCR applies/uses the second beam information in the second time resource (to perform forwarding, or to perform uplink/downlink forwarding); or the NCR applies/uses the third beam information in the third time resources (to perform forwarding, or to perform uplink/downlink forwarding).

Optionally, the NCR applying/using one of the first indication information, the second indication information and the third indication information in the overlapping part of the first time resource, the second time resource and the third time resource means that the NCR applies/uses one of the first beam information, the second beam information and the third beam information in the overlapping part of the first time resource, the second time resource and the third time resources (to perform forwarding, or to perform uplink/downlink forwarding).

Optionally, the first beam (information) and the second beam (information) are different. For example, the first beam information corresponds to/is associated with the first beam. The second beam information corresponds to/is associated with the second beam. Optionally, the first beam information and the second beam information are different. Optionally, the first beam information and the second beam information being different means that an index corresponding to the first beam information is different from an index corresponding to the second beam information. For example, the first beam information is beam #1 (that is, a beam index is 1); the second beam information is beam #2 (that is, a beam index is 2). At this time, the first beam information and the second beam information are different. It can be understood that the NCR will perform the above behavior under the condition that the first beam information and the second beam information are different.

Optionally, the first beam (information) and the third beam (information) are different. For example, the first beam information corresponds to/is associated with the first beam. The third beam information corresponds to/is associated with the third beam. Optionally, the first beam information and the third beam information are different. Optionally, the first beam information and the third beam information being different means that an index corresponding to the first beam information is different from an index corresponding to the third beam information. For example, the first beam information is beam #1 (that is, a beam index is 1); the third beam information is beam #2 (that is, a beam index is 2). At this time, the first beam information and the third beam information are different. It can be understood that the NCR will perform the above behavior under the condition that the first beam information and the third beam information are different.

Optionally, the second beam (information) and the third beam (information) are different. For example, the second beam information corresponds to/is associated with the second beam. The third beam information corresponds to/is associated with the third beam. Optionally, the second beam information and the third beam information are different. Optionally, the second beam information and the third beam information being different means that an index corresponding to the second beam information is different from an index corresponding to the third beam information. For example, the second beam information is beam #1 (that is, a beam index is 1); the third beam information is beam #2 (that is, a beam index is 2). At this time, the second beam information and the third beam information are different. It can be understood that the NCR will perform the above behavior under the condition that the second beam information and the third beam information are different.

This example provides a method for determining the (access link) beam of the NCR. The method can enable the NCR to correctly process/use/determine the corresponding beam in the case that multiple beam-related indications (for example, three different types of access link beam indications) are obtained, thereby improving the link quality of the access link and improving the performance of the communication system.

### EXAMPLE 20

An NCR-MT can be configured to monitor PDCCH according to UE-specific Search space (USS) sets for detection of a DCI format 2_8. Optionally, the DCI format 2_8 is CRC (Cyclic Redundancy Check, CRC) scrambled by an NCR-RNTI. Optionally, a time resource and a corresponding beam index for transmissions or receptions on the access link are indicated by corresponding field(s) in DCI format 2_8. Optionally, the time resource starts at a slot that is offset by K (K≥0) slots from a reference slot. Optionally, K is configured via RRC signaling (received by the NCR/NCR-MT). Optionally, K is indicated/configured by a parameter (e.g., slotOffsetAperiodic) for indicating a slot offset of aperiodic time resource. Optionally, in the slot, the time resource starts at a symbol that is offset by X (X≥0) from the start of the slot. Optionally, X is configured via RRC signaling (received by the NCR/NCR-MT). Optionally, X is indicated/configured by a parameter (e.g., symbolOffset) for indicating a symbol offset in a slot. The time resource has a duration provided by a first parameter for a SCS provided by a second parameter. For example, the duration of the time resource is Y (Y≥0) symbols. Optionally, Y is provided/configured/indicated by a first parameter (e.g., durationInSymbols). Optionally, the SCS of the duration of the time resource is provided/configured/indicated by a second parameter (e.g., ncr-referenceSCS).

At present, the reference slot of time resources (for access link transmission or reception) for the NCR is unclear. The method for determining the reference slot is described in detail below.

### Method 1

The reference slot is the first slot (or the earliest slot) that starts no earlier than the start of slot n+k, where slot n is the slot of PDCCH reception and k is indicated by capability signaling. Optionally, the capability signaling is used for the NCR or NCR-MT. Optionally, the capability signaling is FG 43-3. Optionally, the capability signaling indicates a supported (by the NCR) value of the slot offset k for the reference slot. Optionally, the SCS of k (or the SCS corresponding to k) is based on the SCS of the PDCCH received by the NCR-MT. Optionally, the SCS of the reference slot (or the SCS corresponding to k) is based on/equal to/referring to the SCS indicated/provided by the second parameter. Optionally, the reference slot refers to the slot of the access link (for reception or transmission of the time resource). Optionally, the reference slot refers to the slot (for reception or transmission of the time resource).

### Method 2

The reference slot is the first slot (or the earliest slot) that the start of the slot is no earlier than the start of slot n+k, where slot n is the slot of PDCCH reception and k is indicated by capability signaling. Optionally, the capability signaling is used for the NCR or NCR-MT. Optionally, the capability signaling is FG 43-3. Optionally, the capability signaling indicates a supported (by the NCR) value of the slot offset k for the reference slot. Optionally, the SCS of k (or the SCS corresponding to k) is based on the SCS of the PDCCH received by the NCR-MT. Optionally, the SCS of the reference slot (or the SCS corresponding to k) is based on/equal to/referring to the SCS indicated/provided by the second parameter. Optionally, the reference slot refers to the slot of the access link (for reception or transmission of the time resource). Optionally, the reference slot refers to the slot (for reception or transmission of the time resource).

### Method 3

The reference slot is the first slot (or the earliest slot) that the starting symbol of the slot is no earlier than the starting symbol of slot n+k, where slot n is the slot of PDCCH reception and k is indicated by capability signaling. Optionally, the capability signaling is FG 43-3. Optionally, the capability signaling is used for the NCR or NCR-MT. Optionally, the capability signaling indicates a supported (by the NCR) value of the slot offset k for the reference slot. Optionally, the SCS of k (or the SCS corresponding to k) is based on the SCS of the PDCCH received by the NCR-MT. Optionally, the SCS of the reference slot (or the SCS corresponding to k) is based on/equal to/referring to the SCS indicated/provided by the second parameter. Optionally, the reference slot refers to the slot of the access link (for reception or transmission of the time resource). Optionally, the reference slot refers to the slot (for reception or transmission of the time resource).

### Method 4

The reference slot is the last slot (or the latest slot) that overlaps with slot n+k, where slot n is the slot of PDCCH reception and k is indicated by capability signaling. Optionally, the capability signaling is used for the NCR or NCR-MT. Optionally, the capability signaling is FG 43-3. Optionally, the capability signaling indicates a supported (by the NCR) value of the slot offset k for the reference slot. Optionally, the SCS of k (or the SCS corresponding to k) is based on the SCS of the PDCCH received by the NCR-MT. Optionally, the SCS of the reference slot (or the SCS corresponding to k) is based on/equal to/referring to the SCS indicated/provided by the second parameter. Optionally, the reference slot refers to the slot of the access link (for reception or transmission of the time resource). Optionally, the reference slot refers to the slot (for reception or transmission of the time resource).

### Method 5

The reference slot is the first slot (or the earliest slot) that overlaps with slot n+k, where slot n is the slot of PDCCH reception and k is indicated by capability signaling. Optionally, the capability signaling is used for the NCR or NCR-MT. Optionally, the capability signaling is FG 43-3. Optionally, the capability signaling indicates a supported (by the NCR) value of the slot offset k for the reference slot. Optionally, the SCS of k (or the SCS corresponding to k) is based on the SCS of the PDCCH received by the NCR-MT. Optionally, the SCS of the reference slot (or the SCS corresponding to k) is based on/equal to/referring to the SCS indicated/provided by the second parameter. Optionally, the reference slot refers to the slot of the access link (for reception or transmission of the time resource). Optionally, the reference slot refers to the slot (for reception or transmission of the time resource).

Optionally, the term “not earlier than” can be used interchangeably with “equal to or later than” or “the same as or later than”.

The example provides a method for determining the reference slot of time resources (for access link transmission or reception) for the NCR. The method can avoid the base station and the NCR from having different understandings of the reference slot, thereby improving the reliability of the NCR and the performance of the communication system.

According to various aspects of the disclosure, the described configuration information (or NCR configuration information) received by a repeater from a network device may be transmitted via a radio resource control (RRC), a media access control (MAC) resource element (CE) or downlink control information (DCI).

In addition, “at least one item/at least one” described in the disclosure includes any and/or all possible combinations of listed items, and various embodiments and various examples in embodiments described in the disclosure can be changed and combined in any suitable form, and “/” described in the disclosure represents “and/or”

The illustrative logical blocks, modules, and circuits described in the disclosure may be implemented in a general-purpose processor, a Digital Signal Processor (DSP), an application specific integrated circuit, ASIC), Field Programmable Gate Array (FPGA) or other programmable logic devices, discrete gate or transistor logic, discrete hardware components, or any combination thereof designed to perform the functions described herein. A general-purpose processor may be a microprocessor, but in the alternative, the processor may be any conventional processor, controller, micro-controller, or state machine. A processor may also be implemented as a combination of computing devices, such as a combination of a DSP and a microprocessor, a plurality of microprocessors, one or more microprocessors cooperating with a DSP core, or any other such configuration.

The steps of a method or algorithm described in the disclosure may be embodied directly in hardware, in a software module executed by a processor, or in a combination of the two. Software modules may reside in RAM memory, flash memory, ROM memory, EPROM memory, EEPROM memory, registers, hard disks, removable disks, or any other form of storage media known in the art. An exemplary storage medium is coupled to a processor to enable the processor to read and write information from/to the storage medium. In the alternative, the storage medium may be integrated into the processor. The processor and storage medium may reside in an ASIC. The ASIC may reside in the user terminal. In the alternative, the processor and the storage medium may reside as separate components in the user terminal.

In one or more exemplary designs, the described functions may be implemented in hardware, software, firmware, or any combination thereof. If implemented in software, each function can be stored on or transmitted by a computer-readable medium as one or more instructions or codes. Computer-readable media include both computer storage media and communication media, and the latter includes any media that facilitates the transfer of computer programs from one place to another. The storage medium can be any available medium that can be accessed by a general-purpose or special-purpose computer.

The description set forth herein, taken in conjunction with the drawings, describes example configurations, methods and devices, and does not represent all examples that can be realized or are within the scope of the claims. As used herein, the term “example” means “serving as an example, instance or illustration” rather than “preferred” or “superior to other examples”. The detailed description includes specific details in order to provide an understanding of the described technology. However, these techniques may be practiced without these specific details. In some cases, well-known structures and devices are shown in block diagram form to avoid obscuring the concepts of the described examples.

Although this specification contains many specific implementation details, these should not be interpreted as limitations on any invention or the scope of the claimed protection, but as descriptions of specific features of specific embodiments of specific inventions. Some features described in this specification in the context of separate embodiments can also be combined in a single embodiment. On the contrary, various features described in the context of a single embodiment can also be implemented separately in multiple embodiments or in any suitable sub-combination. Furthermore, although features may be described above as functioning in certain combinations, and even initially claimed as such, in some cases, one or more features from the claimed combination may be deleted from the combination, and the claimed combination may be directed to a subcombination or a variation of a subcombination.

It should be understood that the specific order or hierarchy of steps in the method of the disclosure is illustrative of an exemplary process. Based on the design preference, it can be understood that the specific order or hierarchy of steps in the method can be rearranged to realize the functions and effects disclosed in the disclosure. The appended method claims present elements of various steps in an example order, and are not meant to be limited to the particular order or hierarchy presented, unless otherwise specifically stated. Furthermore, although elements may be described or claimed in the singular, the plural is also contemplated unless the limitation on the singular is explicitly stated. Therefore, the disclosure is not limited to the illustrated examples, and any means for performing the functions described herein are included in various aspects of the disclosure.

Text and drawings are provided as examples only to help readers understand the disclosure. They are not intended and should not be construed to limit the scope of the disclosure in any way. Although certain embodiments and examples have been provided, based on the disclosure herein, it is obvious to those skilled in the art that changes can be made to the illustrated embodiments and examples without departing from the scope of the disclosure.

Those skilled in the art will understand that the various illustrative logical blocks, modules, circuits, and steps described in this application may be implemented as hardware, software, or a combination of both. To clearly illustrate this inter-changeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

In the above-described embodiments of the disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors co-operating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been shown and described with reference to various embodiments thereof, it will be understood by those skilled in the art that various changes in form and details may be made therein without departing from the spirit and scope of the disclosure as defined by the appended claims and their equivalents.

1. A method performed by an NCR (network-controlled repeater) in a wireless communication system, the method comprising:
receiving downlink control information (DCI) by monitoring a PDCCH (physical downlink control channel); and
identifying a first time resource for a communication on an access link based on the DCI;
wherein the first time resource starts at a slot which is offset by a configured slot from a reference slot, and
wherein the reference slot is a first slot that start no earlier than a start of a second slot which is after a third slot in which the PDCCH is received.

2. The method of claim 1, wherein the configured slot is configured by a higher layer signaling.

3. The method of claim 1, wherein the first time resource starts at a symbol which is offset by a configured symbol from the start of the slot.

4. The method of claim 1, wherein a SCS (subcarrier spacing) of the first time resource is based on a SCS of the reference slot.

5. The method of claim 1, further comprising:
identifying a second time resource based on a high layer signaling which overlaps with the first time resource in a set of symbols,
wherein the first time resource is associated with a first beam index and the second time resource is associated with a second beam index;
applying the first beam index or the second beam index for transmission or reception on the access link in the set of symbols.

6. The method of claim 5,
in case that the second time resource is associated with a priority indicator,
the method further comprising:
applying the second beam index for transmission or reception on the access link.

7. The method of claim 5,
in case that the second time resource is not associated with a priority indicator,
the method further comprising:
applying the first beam index for transmission or reception on the access link.

8. An NCR (network-controlled repeater) in a wireless communication system, the NCR comprising:
a transceiver; and
a processor coupled with the transceiver;
wherein the processor configured to:
receive downlink control information (DCI) by monitoring a PDCCH (physical downlink control channel); and
identify a first time resource for a communication on an access link based on the DCI;
wherein the first time resource starts at a slot which is offset by a configured slot from a reference slot, and
wherein the reference slot is a first slot that start no earlier than a start of a second slot which is after a third slot in which the PDCCH is received.

9. The NCR of claim 8, wherein the configured slot is configured by a higher layer signaling.

10. The NCR of claim 8, wherein the first time resource starts at a symbol which is offset by a configured symbol from the start of the slot.

11. The NCR of claim 8, wherein a SCS (subcarrier spacing) of the first time resource is based on a SCS of the reference slot.

12. The NCR of claim 8, the processor further configured to:
identify a second time resource based on a high layer signaling which overlaps with the first time resource in a set of symbols,
wherein the first time resource is associated with a first beam index and the second time resource is associated with a second beam index;
applying the first beam index or the second beam index for transmission or reception on the access link in the set of symbols.

13. The NCR of claim 12,
in case that the second time resource is associated with a priority indicator,
the processor further configured to:
applying the second beam index for transmission or reception on the access link.

14. The NCR of claim 12,
in case that the second time resource is not associated with a priority indicator,
the processor further configured to:
applying the first beam index for transmission or reception on the access link.

15. The NCR of claim 8, wherein the configured symbol is configured by a high layer signaling.
